(19) United States
(12) Patent Application Publication
(10) Pub. No.: US 2023/0278434 A1
(43) Pub. Date: Sep. 7, 2023

(54) CAPTURE ARM SYSTEM FOR MAGNETIC LEVITATION / ROAD VEHICLE

(71) Applicant: Terence Alan Tamutus, Hamilton, NJ (US)

(72) Inventor: Terence Alan Tamutus, Hamilton, NJ (US)

(21) Appl. No.: 18/306,858

(22) Filed: Apr. 25, 2023

Related U.S. Application Data
(63) Continuation-in-part of application No. 17/519,172, filed on Nov. 4, 2021.
(60) Provisional application No. 63/113,091, filed on Nov. 12, 2020.
(60) Provisional application No. 63/337,341, filed on May 2, 2022.

(51) Int. Cl. B60L 13/10; B60L 13/04; B60L 13/03; B61B 3/02

(52) U.S. Cl. CPC B60L 13/10; B60L 13/04; B60L 13/03; B61B 3/02; B60L 2200/26

(57) ABSTRACT

A coupler or magnetic levitation interface is configured to controllably and repeatedly engage with and disengage from a body configured to contain at least one passenger and/or cargo and to be propelled via magnetic levitation along a portion of a magnetic rail system or magnetic track.

### CLAIM OF PRIORITY

This application is a continuation-in-part from U.S. patent application Ser. No. 17/519,172, filed Nov. 4, 2021 and which claims the benefit of priority to U.S. Provisional Appl. No. 63/113,091 filed on Nov. 12, 2020, which is incorporated in its entirety by reference herein. This application also claims the benefit of priority to U.S. Provisional Appl. No. 63/337,341, filed May 2, 2022, which is incorporated in its entirety by reference herein.

### BACKGROUND

### Field

This application relates generally to magnetic levitation rail systems and vehicles configured to be propelled along magnetic levitation rail systems and to be self-propelled along conventional infrastructure.

### Description of the Related Art

In the 30 years between 2020 and 2050, the world's population is expected to increase from 7.6 billion to 9.4 billion: an almost 25% increase. Farms and housing will use more land as the population increases and there may not be sufficient space for creating new transportation infrastructure like wider highways, Hyperloops, or high speed rail. Carbon emissions are already rising with plane, truck, and car traffic, and efforts will be made to provide new, low cost, green methodologies to reduce emissions and traffic congestion, maximize existing infrastructure, minimize infrastructure maintenance costs, increase commerce, and utilize renewable energies.

Throughout the world, new high speed and light rail systems currently have massive cost over runs in areas like California and for Hawaii's HART Rail. Billions of dollars were spent for land rights to erect these rails. Studies say that the capital cost range is $24-42 billion in 2017 dollars, or about $80-140 million per mile.

Magnetic levitation (maglev) transportation uses magnets to move vehicles over a system of rails. One set of magnets of the rail repels and pushes the vehicle up off the track, and a second set of magnets moves the elevated vehicle forward. This form of transportation uses less power than other forms of transportation by eliminating rolling resistance and reducing friction. There are multiple types of maglev technologies currently available. For example, electromagnetic suspension (EMS) uses the attractive magnetic force of a magnet beneath a rail to lift the vehicle and electrodynamic suspension (EDS) uses a repulsive force between two magnetic fields to push the vehicle away from the maglev track. Passive magnetic systems (e.g., used in vacuum tube train (“vactrain”) systems) are a third option. Maglev systems have been more expensive to build than conventional train systems, although the simpler construction of maglev vehicles makes them lower cost to manufacture and maintain.

### SUMMARY

In certain implementations, a vehicle comprises a body configured to contain at least one passenger and/or cargo, and an engine, a drivetrain, and a plurality of wheels in mechanical communication with the body and configured to propel the body along road surfaces. The vehicle further comprises at least one coupler in mechanical communication with the body. The at least one coupler is configured to controllably and repeatedly engage with and be propelled along an elevated portion of a magnetic rail system and to controllably and repeatedly disengage from the elevated portion of the magnetic rail system.

In certain implementations, a magnetic levitation track system comprises a first track portion and a second track portion. The first track portion is configured to controllably engage with a capture arm extending from a vehicle below the first track portion. The second track portion is configured to receive the capture arm from the first track portion and to have the vehicle travel along the at least one second track portion. The second track portion comprises a slot configured to receive the capture arm from the first track portion.

In certain implementations, a vehicle comprises a body configured to contain at least one passenger and/or cargo, and an engine, a drivetrain, and a plurality of wheels in mechanical communication with the body and configured to propel the body along road surfaces. The vehicle further comprises at least one magnetic levitation interface in mechanical communication with a lower portion of the body. The at least one magnetic levitation interface is configured to controllably and repeatedly engage with and be propelled along a magnetic track below the body and to controllably and repeatedly disengage from the magnetic track.

### BRIEF DESCRIPTION OF THE DRAWINGS

FIG. 1A schematically illustrates an example vehicle in accordance with certain implementations described herein.

FIG. 1B schematically illustrates an example vehicle attached to an example rail of a magnetic rail system in accordance with certain implementations described herein.

FIG. 2A schematically illustrates a cross-sectional view of an example at least one coupler engaged with an example rail of the magnetic rail system in accordance with certain implementations described herein.

FIGS. 2B-2D schematically illustrate various example configurations of the magnetic fields extending within the slot between the rail and the coupler and the forces applied to the coupler by the magnetic fields in accordance with certain implementations described herein.

FIGS. 3A and 3B schematically illustrate two example battery recharging systems in which the at least one coupler comprises at least one magnetic induction coil configured to wirelessly receive power from the rail of the magnetic rail system in accordance with certain implementations described herein.

FIGS. 4A and 4B schematically illustrate two example communication systems in which the at least one coupler comprises at least one communication device configured to wirelessly transmit signals to and/or receive signals from the magnetic rail system in accordance with certain implementations described herein.

FIGS. 5A and 5B schematically illustrate an example rail and example coupler having a plurality of rollers in accordance with certain implementations described herein.

FIG. 6 schematically illustrates an example coupler comprising a cable release mechanism in accordance with certain implementations described herein.

FIGS. 7A and 7B schematically illustrate a side view and a front view, respectively, of a vehicle comprising one or more aerodynamic elements in accordance with certain implementations described herein.

FIGS. 8A and 8B schematically illustrate the at least one coupler in an extended position and in a retracted position, respectively, in accordance with certain implementations described herein.

FIG. 8C schematically illustrates the vehicle with the wheels retracted into the body to reduce drag in accordance with certain implementations described herein.

FIGS. 9A-9C schematically illustrate various example vehicles comprising a stabilization system in accordance with certain implementations described herein.

FIG. 10 schematically illustrates two example vehicles travelling in substantially opposite directions along two magnetic tracks that are substantially parallel to one another in accordance with certain implementations described herein.

FIGS. 11A and 11B schematically illustrate a front view and bottom view, respectively, of an example vehicle comprising a plurality of magnetic levitation interfaces that are part of at least one wheel rim of at least one wheel in accordance with certain implementations described herein.

FIGS. 12A and 12B schematically illustrate a front view and bottom view, respectively, of an example vehicle comprising a plurality of magnetic levitation interfaces that are affixed to an underside of the vehicle in accordance with certain implementations described herein.

FIGS. 13A and 13B schematically illustrate two view of another example vehicle and an example magnetic rail system in accordance with certain implementations described herein.

FIGS. 14A-14E schematically illustrate example magnetic rail systems in accordance with certain implementations described herein.

FIGS. 15A-15E schematically illustrate examples of entry/exit stations compatible with certain implementations described herein.

FIG. 15F schematically illustrates a side view of an example coupler configured to be attachable to and detachable from a vehicle and/or a shipping container while the coupler remains on the rail in accordance with certain implementations described herein.

FIG. 15G schematically illustrates a side view of the coupler of FIG. 15F prior to being attached to a vehicle and/or subsequent to being detached from the vehicle in accordance with certain implementations described herein.

FIG. 15H schematically illustrates a side view of the coupler of FIG. 15F attached to the vehicle in accordance with certain implementations described herein.

FIG. 15I schematically illustrates a top view of a coupler traveling along magnetically activated linear track portions in accordance with certain implementations described herein.

FIGS. 16A and 16B schematically illustrate views along the longitudinal axis of two example rails of an entry lane of an entry/exit ramp in accordance with certain implementations described herein.

FIG. 17 schematically illustrates a plurality of vehicles traveling along a magnetic rail system coupled to an outside portion of a vacuum tube train system in accordance with certain implementations described herein.

FIG. 18 schematically illustrates a vehicle 10 comprising a coupler compatible for interfacing with an elevated magnetic rail system and a magnetic levitation interface compatible for interfacing with railroad rails in accordance with certain implementations described herein.

FIGS. 19A-19C schematically illustrate a series of example steps performed by an example construction system configured to lay rails of an example magnetic rail system in accordance with certain implementations described herein.

FIG. 20 schematically illustrates a magnetic rail system configured to move intermodal shipping containers in accordance with certain implementations described herein.

### DETAILED DESCRIPTION

### Overview

Certain implementations described herein provide a compact, magnetic levitation vehicle: a road vehicle that can attach to a levitated and/or suspended magnetic rail system. The vehicle can be a personal vehicle configured to transport one or more passengers and/or a delivery vehicle configured to transport cargo. In certain implementations, the vehicle can travel on conventional infrastructure (e.g., roads, bridges, viaducts, highways, and/or streets). The vehicle drives to a local station, much like a bus stop or rail-train station, where an adapter engages the magnetic rail track. The vehicle can then travel autonomously along the magnetic rail system to another station and disengage from the rail system leaving the vehicle free to travel on conventional infrastructure (e.g., a road) to its final destination. To make the transition from the conventional infrastructure to the novel rail system, this vehicle can use a capture arm and/or an undercarriage magnetic levitation system. This vehicle can also use an adapter to travel on conventional railroad tracks. The vehicle of certain implementations can be used in conjunction with current or future low speed or high speed rail systems.

Certain implementations described herein provide a capture arm and/or an undercarriage magnetic levitation system that is controllably and repeatedly attachable to and detachable from a road vehicle or a shipping container (e.g., ISO container conforming to specifications of the International Organization for Standardization) and that is configured to be attached to the magnetic rail system. For example, the capture arm can comprise at least one mechanical grip or other connectors configured to controllably and repeatedly latch onto the vehicle and/or container. The vehicle can use the capture arm less than 70% of the time and the capture arm can reside on the magnetic rail system (e.g., in order to reduce the overall cost of the vehicle and/or to allow for lighter, more energy-efficient vehicles). The capture arm can be equipped with batteries for back-up power, additional stabilizers and controllers (e.g., in addition to any stabilizers or controllers of the vehicle), motors for emergency track exiting, and/or inductive or conductive power connections (e.g., configured to connect with a power source from the rail system).

In certain implementations, the vehicle runs both on magnetic levitation (“maglev”) rails and on conventional roads (e.g., streets, highways, etc.). The vehicle can use a magnetic track system to travel on, over, under, and/or near existing highways at high speeds, within a programmed or autonomous network. The vehicle can then disengage from the maglev rail system at a local station so it can travel to its destination (e.g., house; store), over conventional roads using its own wheels and drive system. In certain implementations, the vehicle can be compatible for use with a vacuum tube train (“vactrain”) system in which the vehicle moves with reduced air resistance and concomitant increases in speed. For example, the vehicle can comprise retractable wheels to make it adaptable to a vactrain system or other transport systems.

In certain implementations, the vehicle is an ecological and energy efficient electric vehicle and is powered directly from a centralized power grid. Such a vehicle does not utilize crude oil pumped to the surface in one country, shipped to another, refined, and driven by a truck to a gas station, then carried by the vehicle to be released into the atmosphere, with no hope of carbon capture. In certain implementations, the vehicle is battery powered and is charged by the maglev track during travel, thereby avoiding utilizing electric battery charging stations. Such a vehicle can avoid using its own battery power while traveling on the maglev track, instead receiving power from a power grid of the maglev track. In certain implementations, the vehicle and maglev track system does not require the construction of sound barrier walls near home developments as it is silent and does not create sounds from engines or tires traveling on asphalt. In certain implementations, the vehicle and maglev track system does not require steel or concrete barriers for crash prevention into oncoming lanes as the maglev track system is a guideway for the vehicles. In certain implementations, the vehicle and the maglev track system reduces repairs to the existing infrastructure since its own minimalist rail system removes vehicles from road and bridges, thereby reducing or eliminating fatigue on bridges and wear on roadways. By using many more vehicles for transporting cargo than large trucks and scheduling such vehicles for transport during off peak hours, certain implementations can also reduce infrastructure wear and can speed deliveries.

In certain implementations, the vehicles are configured to operate autonomously on the maglev track (e.g., not requiring a driver). For example, when a vehicle is on a highway, the vehicle can be completely self-driving and self-navigating. The vehicle of certain implementations is on a maglev track networked grid, such that accidents and/or collisions are reduced or eliminated. In certain implementations, the spacing between vehicles on the maglev track is computer-controlled, so vehicles can be spaced more closely together, thereby maximizing vehicle occupancy while maintaining high speed velocity transport. For example, vehicles can be several feet apart and can travel at over 100 miles per hour (e.g., over 300 miles per hour).

In certain implementations, a maglev track system can be added onto existing infrastructure (e.g., elevated rail, air space, etc.) for vehicles to travel on. The maglev track system can comprise multiple on/off ramps, and such on/off ramps can be added at a lower cost than a single train station platform, even excluding the additional cost of the parking lot. In addition, a vehicle owner does not have to rely on a train schedule or train station parking availability. In certain implementations, the maglev track system does not require parking lots since the maglev train commuter is using their own vehicle on the rail. Most infrastructure for trains (e.g., low speed rail systems; high speed rail systems; light rail systems) have the electrical infrastructure in place to power a maglev track system and vehicles in accordance with certain implementations described herein.

For example, the maglev track system of certain implementations can utilize otherwise wasted space of the U.S. rail network (e.g., unoccupied by active commuter or freight trains), which are an expensive asset. Optimizing this rail space can reduce future highway traffic as well as train station crowding. Where there are conflicts for track usage, a piggybacking subsystem can be constructed for the maglev track system such that the track can be mounted under a rail viaduct, on the side of, or above rail traffic. In certain implementations, the maglev track system provides new economic growth opportunities for railway owners while reducing capital investment and maintenance expense for passenger vehicles, engines, station cleaning, in-person ticketing, etc.

For another example, the maglev track system of certain implementations can utilize empty air space above highways and/or empty and unoccupied space in the median strip. This empty air space could be easily occupied by a high density of vehicles and can reduce highway on-road traffic. By optimizing state and federal land, certain implementations can avoid land right battles for future expansion—another vital reason for such infrastructure development.

For another example, the maglev track system of certain implementations can utilize a maglev rail and low pressure (e.g., vacuum) tube network (“vactrain”), in which travel may still be dependent on a train schedule. In certain implementations, the vehicles can be used and/or adaptable for use with a vactrain transportation system by which the vehicles travel in a low pressure region where minimal air resistances and reduced turbulence increase possible travel speed. A vehicle of certain implementations can include one or more safety features configured to run on a maglev track system, in a vactrain network, and/or on its own wheels. For example, a vehicle of certain implementations can be inserted between scheduled vactrain trains. A maglev track system could also be mounted to the vactrain's exterior superstructure or as a piggybacking subsystem, with the maglev track system external to the low pressure region. In certain such implementations, the vehicle is configured to enter and exit at more local, smaller, less costly on-off stations to take a passenger the rest of the commute. Certain such implementations can also utilize land right-of-ways. Rail and vactrain vehicles can be dedicated for use on a controlled track. The vehicle capture arm system and/or undercarriage maglev system of certain implementations can allow versatility.

### Example Magnetic Levitation Vehicles

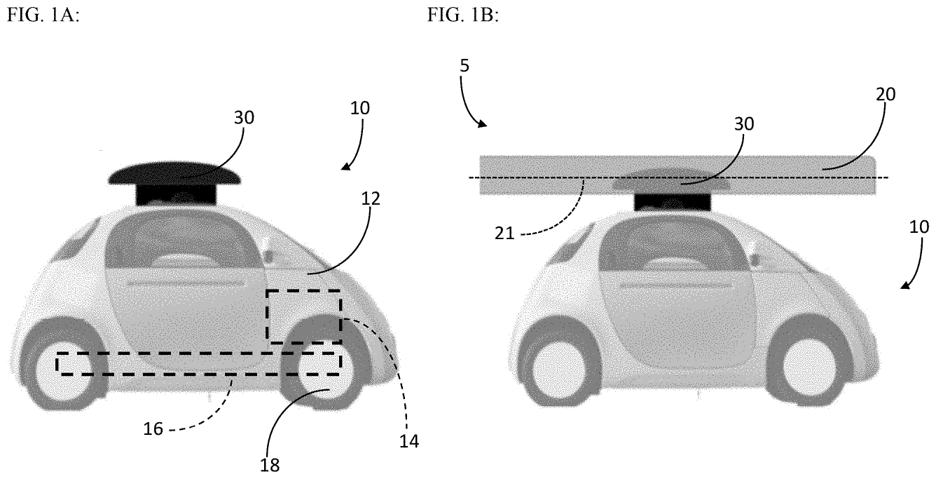

FIG. 1A schematically illustrates an example vehicle 10 in accordance with certain implementations described herein, and FIG. 1B schematically illustrates the vehicle 10 attached to an example rail 20 (e.g., track; guideway) of a magnetic rail (e.g., maglev) system 5 in accordance with certain implementations described herein. The vehicle 10 comprises a body 12 configured to contain at least one passenger and/or cargo and an engine 14, a drivetrain 16, and a plurality of wheels 18 in mechanical communication with the body 12 and configured to propel the body 12 along road surfaces. The vehicle 10 further comprises at least one coupler 30 in mechanical communication with the body 12. The at least one coupler 30 is configured to controllably and repeatedly engage with and be propelled along an elevated portion of the magnetic rail system 5 (e.g., along a longitudinal axis 21 of the rail 20) and to controllably and repeatedly disengage from the elevated portion of the magnetic rail system 5 (e.g., using the engine 14, drivetrain 16, and wheels 18; to travel to a local or final destination where the magnetic rail system 5 does not exist).

In certain implementations, the vehicle 10 is a street-legal vehicle that includes the at least one coupler 30. The body 12 can comprise fewer components than a conventional automobile and can comprise composite structures for low cost and low weight but high structural strength (e.g., for safety). The engine 14 can comprise an internal combustion engine and/or an electric engine having a rechargeable electric battery (e.g., configured to be recharged while the vehicle 10 is being propelled along the portion of the magnetic rail system 5), such that the battery is fully charged upon the vehicle 10 disengaging from the magnetic rail system 5. The drivetrain 16 can be operationally coupled to the engine 14 and the wheels 18 and can be configured to utilize power from the engine 14 to drive the wheels 18 to propel the vehicle 10 along road surfaces.

In certain implementations, the body 12 of the vehicle 10 comprises electromagnetic shielding configured to inhibit electromagnetic fields from the magnetic rail system 5 from entering a region (e.g., compartment; cabin) containing the at least one passenger and/or cargo. For example, the body 12 can comprise at least one material having a sufficiently high magnetic permeability such that the magnetic fields from the magnetic rail system 5 are below a predetermined threshold within the cabin of the vehicle 10. For another example, the body 12 can comprise at least one electrically conductive material configured to perform as a Faraday cage such that electric fields from the magnetic rail system 5 are below a predetermined threshold within the cabin of the vehicle 10.

In certain implementations, the body 12 of the vehicle 10 comprises a rear entry (e.g., door) configured to allow straight-in access (e.g., for wheelchairs, strollers, carriages, cargo). For example, in a parking lot, the passenger can utilize the rear entry instead of a side door which can have limited access due to an adjacently parked vehicle. The rear entry of certain implementations also comprises a ramp for wheelchairs, strollers, or cargo to be pushed up the ramp and anchored in the vehicle 10. In certain implementations, given the ease of rolling in through the back, some baby carriages can be used to double as a car seat. In certain implementations, the vehicle 10 is also compatible for travel along vacuum train (vactrain) systems and/or railroad track systems.

In certain implementations in which the vehicle 10 is configured to deliver packages and/or goods, the vehicle 10 can comprise robotic arms, drones, unmanned aircraft vehicles (UAV), and/or unmanned aircraft systems (UAS). The vehicle 10 can be configured for autonomous deliveries for low volume deliveries or high volume deliveries. For example, the vehicle 10 can be configured to autonomously drop or place the package (e.g., food; mail) at a home, office, mailbox, or other location.

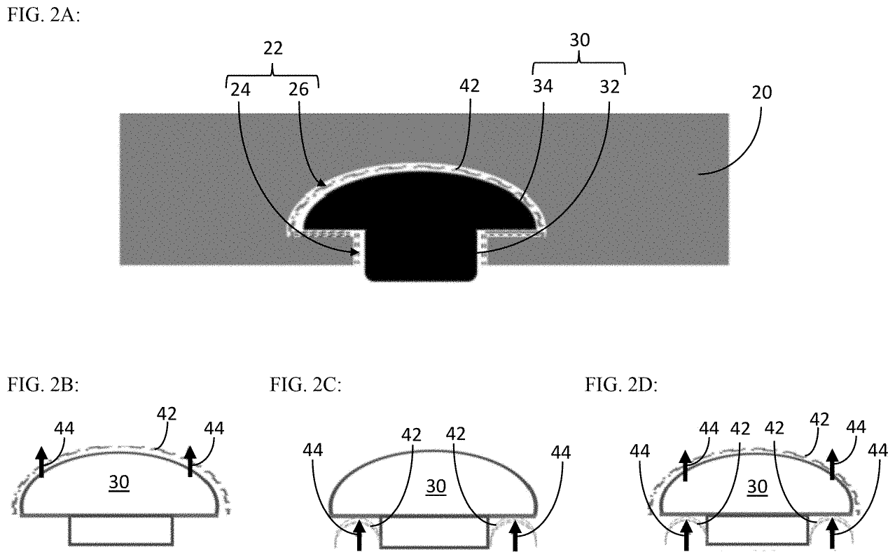

FIG. 2A schematically illustrates a cross-sectional view of an example at least one coupler 30 (e.g., capture arm) engaged with an example rail 20 of the magnetic rail system 5 in accordance with certain implementations described herein. The cross-sectional view of FIG. 2A is in a plane substantially perpendicular to the longitudinal axis 21 of the rail 20 and the body 12 of the vehicle 10 extends downward from the at least one coupler 30 (not shown in FIG. 2A). The example rail 20 of FIG. 2A comprises a slot 22 having a T-shaped cross section in the plane substantially perpendicular to the longitudinal axis 21 of the rail 20, the slot 22 configured to engage with (e.g., receive; mate with) a portion of the example coupler 30 of FIG. 2A, also having a T-shaped cross section in the plane substantially perpendicular to the longitudinal axis 21. For example, the coupler 30 can comprise a first portion 32 extending upwards from the vehicle 10 and a second portion 34 extending substantially perpendicularly to the first portion 32, and the slot 22 can comprises a first portion 24 through which the first portion 32 of the coupler 30 is configured to extend and a second portion 26 configured to receive the second portion 34 of the coupler 30. The second portion 34 of the coupler 30 can have a width in the cross-sectional plane that is wider than the width of the first portion 24 of the slot 22 such that the coupler 30 is substantially enclosed within the slot 22 and is configured to move along the slot 22 along the longitudinal axis 21. In certain implementations, the shape of the slot 22 and the shape of the coupler 30 are configured to keep the coupler 30 engaged with the rail 20 (e.g., mechanically locked together) in the event of an interruption of power to the vehicle 10 and/or the rail 20 or to a collision and/or damage to either the coupler 30 or the rail 20. Other shapes and cross sections of the rail 20 and the coupler 30 beyond those schematically illustrated by FIG. 2A can be used.

In certain implementations, the rail 20 and the at least one coupler 30 are components of a maglev system (not shown) configured to use magnetic levitation to propel the at least one coupler 30 (and the vehicle 10) along the rail 20. FIGS. 2B-2D schematically illustrate various example configurations of the magnetic fields 42 extending within the slot 22 between the rail 20 and the coupler 30 and the forces 44 applied to the coupler 30 by the magnetic fields 42 in accordance with certain implementations described herein. The magnetic fields 42 of certain implementations are generated by the rail 20 and/or the coupler 30. In FIG. 2B, the magnetic fields 42 attracts the coupler 30 upwards (e.g., along a direction substantially perpendicular to the second portion 34 of the coupler 30). In FIG. 2C, the magnetic fields 42 repel the coupler 30 upwards (e.g., along a direction substantially perpendicular to the second portion 34 of the coupler 30). In FIG. 2D, at least some of the magnetic fields 42 attract the coupler 30 upwards and at least some of the magnetic fields 42 repel the coupler 30 upwards.

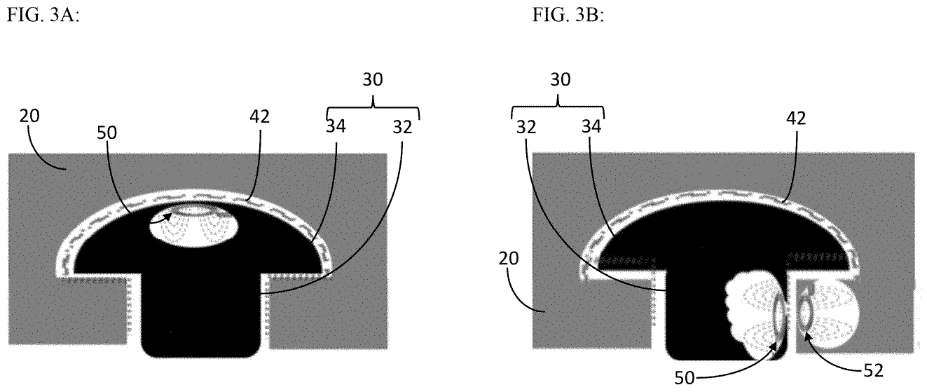

FIGS. 3A and 3B schematically illustrate two example battery recharging systems in which the at least one coupler 30 (e.g., track based or vehicle based) comprises at least one magnetic induction coil 50 configured to wirelessly receive power from the rail 20 of the magnetic rail system 5 in accordance with certain implementations described herein. In certain implementations, the at least one magnetic induction coil 50 is within the first portion 32 of the coupler 30 and/or within the second portion 34 of the coupler 30. For example, as schematically illustrated by FIG. 3A, the magnetic induction coil 50 can comprise a spiral electrically conductive wire within the second portion 34 of the coupler 30 and can be configured to generate electric power in response to interacting with the magnetic fields 42 generated by the rail 20. For another example, as schematically illustrated by FIG. 3B, the magnetic induction coil 50 can comprise a spiral electrically conductive wire within the first portion 32 of the coupler 30 and can be configured to be wirelessly coupled to a plurality of magnetic induction coils 52 of the rails 20 at a plurality of positions along the magnetic rail system 5. In response to interacting with magnetic fields generated by the magnetic induction coil 52, the magnetic induction coil 50 can generate electric power. In certain other implementations, the rail 20 and the coupler 30 can comprise electrical conductors that are configured to contact one another and to transfer electric power from the rail 20 to the coupler 30 (e.g., in a manner similar to a “third rail” of a train). In certain implementations, the magnetic rail system 5 comprises an electric and magnetic power grid that is configured to continuously recharge the vehicle 10 (e.g., via the magnetic induction coil 50 or electrical conductor) while the vehicle 10 is on the rails 20. For example, the electric power received by the coupler 30 from the rail 20 can be used to recharge a battery of the vehicle 10, and power from the battery can be used to propel the vehicle 10 once the vehicle 10 is disengaged from the magnetic rail system 5.

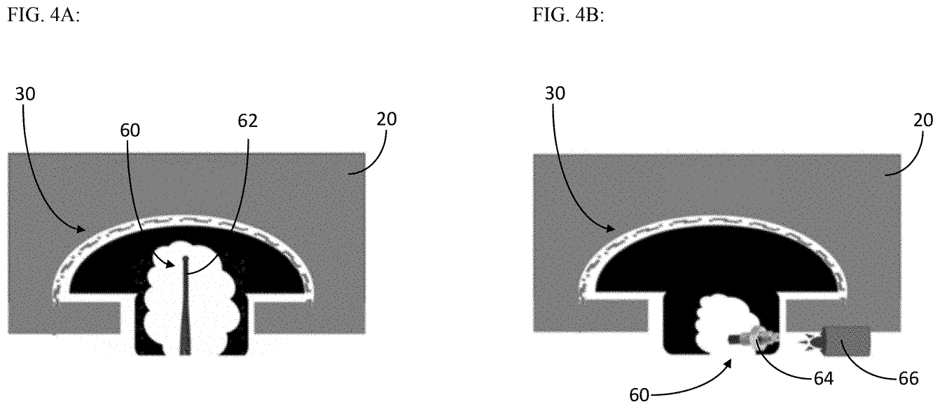

FIGS. 4A and 4B schematically illustrate two example communication systems in which the at least one coupler 30 comprises at least one communication device 60 configured to wirelessly transmit signals to and/or receive signals from the magnetic rail system 5 in accordance with certain implementations described herein. For example, the at least one communication device 60 can comprise at least one antenna 62 (see, e.g., FIG. 4A) configured to wirelessly transmit and/or receive data and/or command signals (e.g., RF signals) from the rail 20 of the magnetic rail system 5. For another example, the at least one communication device 60 can comprise at least one optical device 64 (e.g., optical emitter; laser; LED; fiber optics; optical sensor) (see, e.g., FIG. 4B) configured to wirelessly transmit and/or receive data and/or command signals (e.g., optical signals) from a plurality of optical devices 66 (e.g., optical emitters; laser; LED; fiber optics; optical sensors) of the rails 20 at a plurality of positions along the magnetic rail system 5. While FIG. 4A shows the at least one antenna 62 in a center region of the coupler 30 and FIG. 4B shows the at least one optical device 64 on the first portion 32 of the coupler 30, other positions and/or orientations of the at least one communication device 60 are also compatible with certain implementations described herein. In certain other implementations, the at least one communication device 60 comprises a wired (e.g., electrical connection) communications between the rail 20 and the vehicle 10.

In certain implementations, the at least one communication device 60 is configured to provide communications between the vehicle 10 and a central communication system (e.g., Global Automated Network or GAN) configured to autonomously control the vehicle 10 while engaged with (e.g., travelling along) the magnetic rail system 5 (e.g., to monitor and control vehicle dynamics). The GAN of certain implementations comprises a data-secure collection of one or more super computers, cloud based network, communications, hardware, software, structural health monitoring (SHM), and sensor networks that orchestrate the operation of the magnetic rail system 5 and the vehicles 10. For example, when a vehicle 10 reaches the magnetic rail system 5, the at least one communication device 60 can transmit information to the central network that the vehicle 10 is arriving and to schedule an entrance point onto the magnetic rail system 5, position, speed, route, and exit point off of the magnetic rail system 5. In certain implementations, the vehicle 10 is controlled by a Personal Artificial Intelligence (PAI) to operate even without a passenger.

In certain implementations, the at least one communication device 60 and the magnetic rail system 5 are configured to also connect passengers to high speed internet and phones. The magnetic rail system 5 of certain implementations can be used in conjunction with a separate utility communications infrastructure (e.g., a fiber optic back bone for 5G or other cellular communications). The magnetic rail system 5 of certain implementations can be used as a fiber optic infrastructure back bond or cellular antenna communications in place of cell towers, such as 5G. Electrical and/or optical fiber cables can be run along and within cable trays of the magnetic rail system's superstructure, and these fiber cables can include cable TV, internet service providers, and fiber optic service providers to be accessed by the vehicle 10 at lower costs than using telephone poles or burying cables. The cables can be laid into place by an automated vehicle, which would be particularly useful in rural areas where there are no fiber optic service providers and there is a dependence on low-speed coaxial cable for internet access. The software of certain implementations can include artificial intelligence (AI), autonomous driving programs, asset management, etc.

In certain implementations, the GAN can control various aspects of driving, parking, maintenance, and delivery of goods by the vehicle 10. The GAN of certain implementations can control the entrance point, position, speed, route and exit of all the vehicles 10 on the magnetic rail system 5. For example, the GAN can receive information (e.g., from eddy current or Hall effect sensors on the vehicles 10 and/or rails 20) regarding the positions of the vehicles 10 along the rails 20 and can determine and set the spacing between adjacent vehicles 10 based on the loads and power requirements over the power grid of the magnetic rail system 5, as well as control all of the maglev aspects of the magnetic rail system 5 and work with the supplemental maglev subsystem in the vehicle 10. For another example, the GAN can collect payments (e.g., tolls; fees to rent the vehicle 10; fees to travel on the magnetic rail system 5). The GAN of certain implementations can include data indicative of the structural health of the magnetic rail system 5 (e.g., from a structural health monitoring system) and can route the vehicles 10 accordingly (e.g., to avoid damaged or excessively crowded portions; based on road/street traffic near magnetic rail system's on/off ramps). For example, in response to such data, the GAN can move a vehicle 10 to a different entrance or exit ramp instead of the closest location. The GAN of certain implementations can send messages or data to the passengers in the vehicle 10. Serial codes on the vehicle 10 of certain implementations can ensure that it is fit for service and the vehicle owner has settled accounts allowing for patronage on the magnetic rail system 5. In certain implementations, the GAN can comprise an optical position encoding system (e.g., on the vehicles 10 and/or the rails 20) configured to locate the vehicles 10 along the rails 20 and to control the spacings between the vehicles 20.

In certain implementations, the vehicle 10 and the at least one communication device 60 is further configured to communicate with the GAN when disengaged from the magnetic rail system 5 for autonomous control of the vehicle 10 when off the magnetic rail system 5. The communication signals can include information regarding one or more of: vehicle location, vehicle destination or change of destination, vehicle health, vehicle identification, vehicle registration, payment process information (e.g., if payment is to be paid for travel). For example, the GAN of certain implementations can automate the vehicle 10 while driving on its wheels to a parking space, home garage, or other destination. The GAN of certain implementations can facilitate faster parking by accessing and utilizing information regarding available parking spaces without involvement of the passenger.

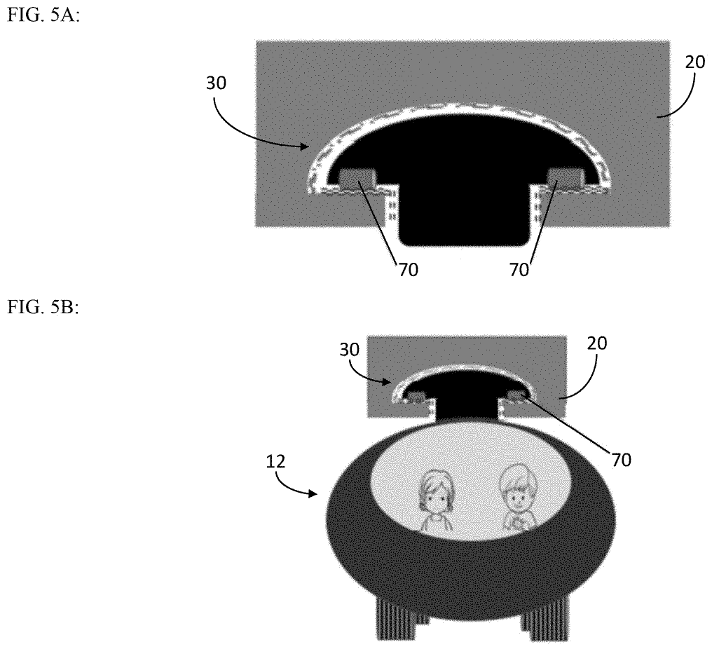

FIGS. 5A and 5B schematically illustrate an example rail 20 and example coupler 30 having a plurality of rollers 70 in accordance with certain implementations described herein. As shown in FIGS. 5A and 5B, the rollers 70 of certain implementations can comprise wheels that can be deployed from the coupler 30 to roll along an inner surface of the rail 20. In certain other implementations, the rollers 70 comprise a plurality of bearings that can be deployed from the inner surface of the rail 20. The rollers 70 are configured to allow the body 12 to be moved along the rail 20 without power being applied to the at least one coupler 30 by the magnetic rail system 5. Certain implementations further comprise a manually operated or automated mechanical pusher (not shown) that is incorporated into the rail 20 configured to push the coupler 30 forward along the rail 20. In certain implementations, in the event of an interruption of power to the rail 20, the vehicle 10 can be propelled magnetically (e.g., self-propelled by magnetic fields generated by the vehicle 10) or mechanically (e.g., non-magnetically; self-propelled by motorized rollers 70) to the nearest disengagement station (e.g., off ramp) so as to avoid being stranded on the magnetic rail system 5.

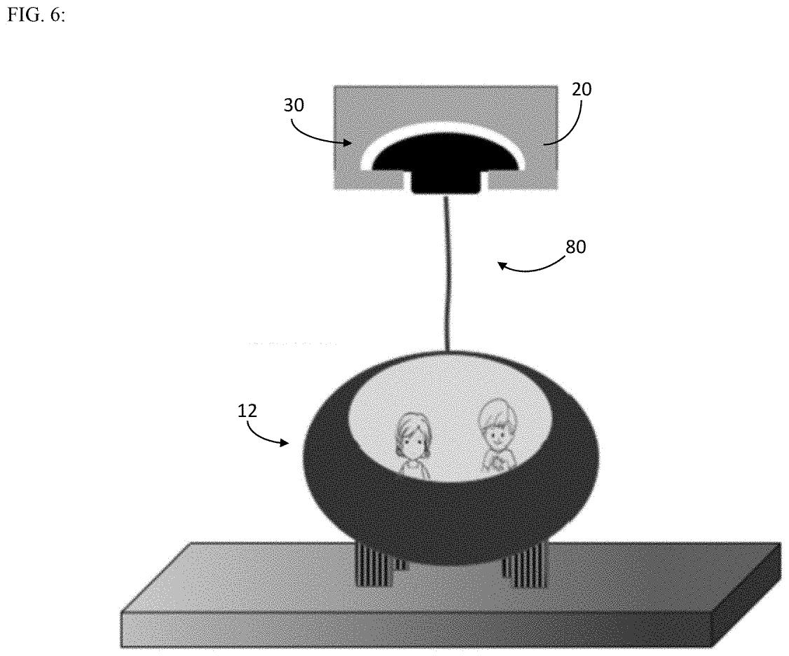

FIG. 6 schematically illustrates an example coupler 30 comprising a cable release mechanism 80 in accordance with certain implementations described herein. The cable release mechanism 80 is configured to allow the body 12 to be controllably and safely lowered from the rail 20 (e.g., in the event of an emergency or power failure to the magnetic rail system 5). In certain implementations, the cable release mechanism 80 is configured to allow the body 12 to be lowered from the rail 20 and can comprise a high strength coiled cable (e.g., one-time-use) that is released for emergency egress and that lowers the body 12 to the ground. Thus, if the power of the magnetic rail system 5 fails, the one or more passengers are not stranded on the rail 20. In certain implementations, the cable release mechanism 80 is disabled (e.g., unable to be deployed) while the vehicle 10 and the magnetic rail system 5 are functioning properly. In certain implementations, instead of responding to a loss of power in the magnetic rail system 5 by deploying the cable release mechanism 80, the vehicle 10 can use its own maglev propulsion and its electric battery power to function as an emergency supplemental maglev system (e.g., which can be part of a pitch-yaw-roll (PYR) stabilization system 90 of the vehicle 10) to create a magnetic field configured to slowly move the vehicle 10 to exit the magnetic rail system 5 at an on/off ramp.

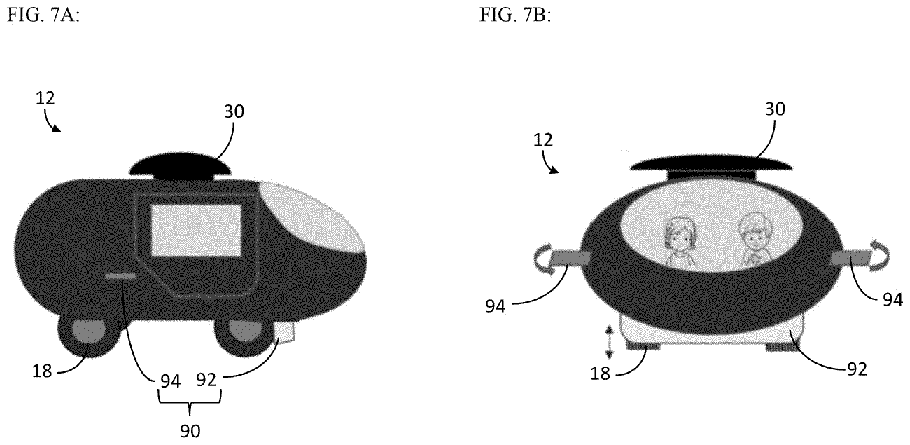

FIGS. 7A and 7B schematically illustrate a side view and a front view, respectively, of a vehicle 10 comprising one or more aerodynamic elements 90 in accordance with certain implementations described herein. The aerodynamic elements 90 are configured to reduce air drag and/or to provide aerodynamic stability to the body 12 while the vehicle 10 is being propelled along the magnetic rail system 5 (e.g., to provide reduced air turbulence, improved stability, quieter and smoother ride for passengers traveling at high speeds). For example, the one or more aerodynamic elements 90 can comprise a fairing 92 configured to be placed in front of the wheels 18 of the vehicle 10. The fairing 92 can be configured to be controllably extended and retracted such that the fairing 92 is in an aerodynamic location on the vehicle 10 (e.g., in front of the wheels 18) while the vehicle 10 is traveling along the magnetic rail system 5 and is retracted from the aerodynamic location (e.g., away from the wheels 18) when the vehicle 10 is not traveling along the magnetic rail system 5 (e.g., driving along a road surface). In certain implementations, the fairing 92 is configured to make the vehicle 10 neutrally buoyant in air such that the vehicle 10 is not pulling down on the magnetic fields 42 nor pushing up towards the rail 20. For another example, the one or more aerodynamic element 90 can comprise one or more wings 94 (e.g., ailerons) configured to extend from the body 12 (e.g., from the left and right sides of the body 12 as shown in FIGS. 7A and 7B). The wings 94 can be configured to be controllably extended and retracted such that the wings 94 are in position while the vehicle 10 is traveling along the magnetic rail system 5 and are retracted into the body 12 when the vehicle 10 is not traveling along the magnetic rail system 5 (e.g., driving along a road surface). In certain implementations, the wings 94 provide lift to the vehicle 10 and/or are adjustable to improve stability of the vehicle 10 during travel along the magnetic rail system 5.

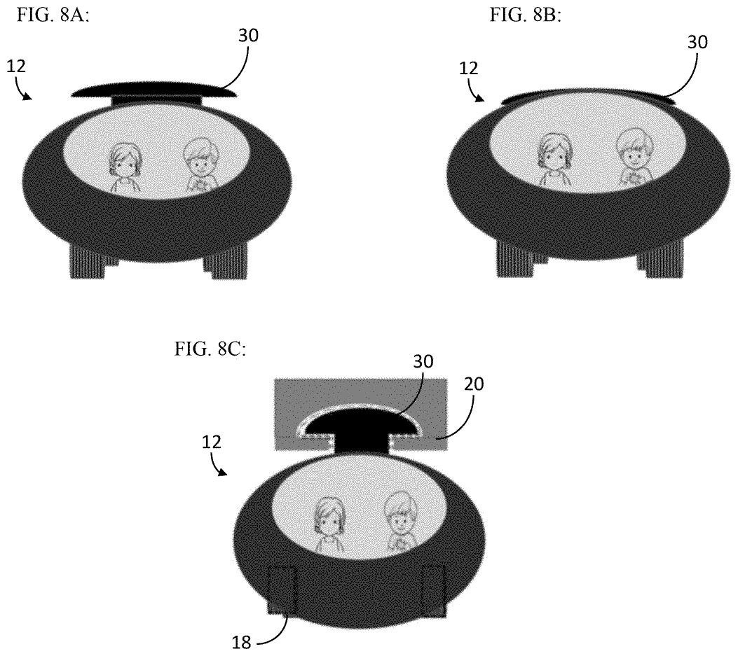

FIGS. 8A and 8B schematically illustrate the at least one coupler 30 (e.g., vehicle based) in an extended position and in a retracted position, respectively, in accordance with certain implementations described herein. The coupler 30 can be configured to be controllably extended from the body 12 prior to and in preparation for engaging the magnetic rail system 5 and to be controllably retracted back to the body 12 upon the vehicle 10 disengaging from the magnetic rail system 5 (e.g., by a motor or by a manual extension/retraction mechanism). In certain implementations, the coupler 30 can be locked (e.g., affixed to the body 12 to be unmovable) in the extended position while engaged with the magnetic rail system 5 to provide enhanced structural integrity. With the coupler 30 in the retracted position, the aerodynamics of the vehicle 10 can be improved for driving along road surfaces and to protect the coupler 30 from inadvertent damage. In certain implementations, the extension and retraction of the coupler 30 can be performed automatically (e.g., extended upon entering a station; retracted upon leaving a station), thereby avoiding accidents caused by driver error while engaging the magnetic rail system 5. FIG. 8C schematically illustrates the vehicle 10 with the wheels 18 retracted into the body 12 (e.g., automatically upon engaging with the magnetic rail system 5) to reduce drag in accordance with certain implementations described herein.

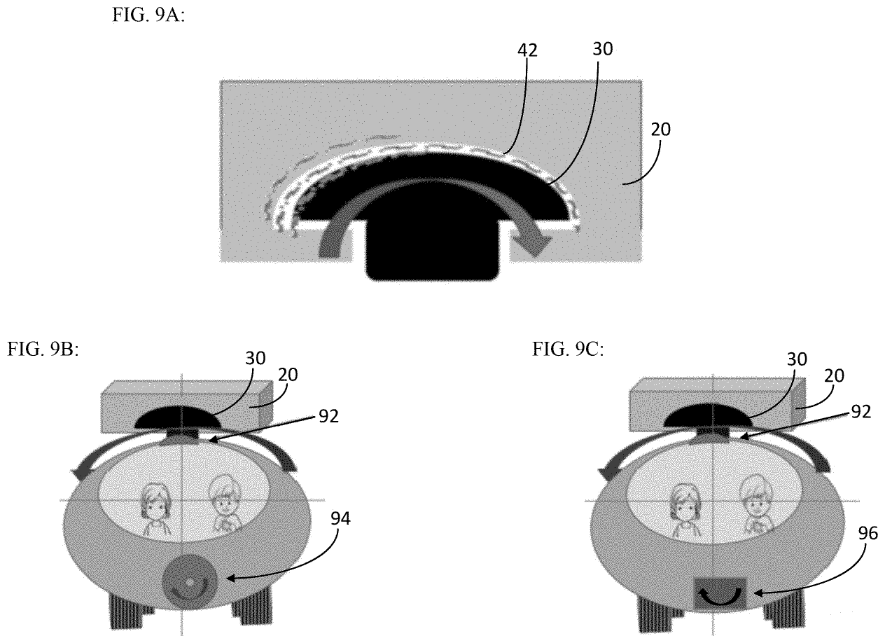

FIGS. 9A-9C schematically illustrate various example vehicles 10 comprising a stabilization system 90 in accordance with certain implementations described herein. The vehicle 10 can experience unwanted motion (e.g., swaying; shimmy; side-to-side; pitch; yaw; roll; vibrations; jitter; accelerations; decelerations) that would make passengers uncomfortable. The stabilization system 90 of certain implementations comprises at least one sensor (e.g., one or more accelerometers and/or gyroscopes) configured to detect motion (e.g., pitch, yaw, and roll) and/or an orientation of the vehicle 10 and/or the at least one coupler 30 relative to the rail 20 and/or the earth. In certain implementations, the stabilization system 90 is configured to receive and respond to information (e.g., regarding the location of the vehicle 10 and the configuration of the rails 20 at the location) from a central communication system (e.g., Global Automated Network or GAN) to stabilize the vehicle 10. The stabilization system 90 can be configured to transmit information from the at least one sensor to the central communication system to provide data (e.g., indicative of current conditions at the rail 20) for use in stabilizing other vehicles 10 traveling along the rail 20 after the vehicle 10. The stabilization system 90 can be configured to autonomously counter the detected motion and/or adjust the orientation in response to signals from the at least one sensor. In certain implementations, the stabilization system 90 is configured to compensate, in real-time, for movement of passengers and/or cargo within the vehicle 10 and/or for rail variations or misalignments, resulting in a more comfortable and steady travel path.

In certain implementations, as schematically illustrated by FIG. 9A, the stabilization system 90 can comprise the magnetic fields 42 between the rail 20 and the coupler 30. In response to signals from the at least one sensor indicative of unwanted motion of the vehicle 10 in one direction, the stabilization system 90 can adjust (e.g., boost) the magnetic fields 42 (e.g., cause a magnetic field variance) to apply a counteracting force on the coupler 30 to reduce (e.g., dampen; eliminate) the magnitude of the unwanted motion of the vehicle 10, thereby stabilizing the vehicle 10. In certain implementations, the magnetic fields 42 can have locational variations along the rail 20 to compensate for areas of known motion (e.g., caused by turns in the rail 20).

In certain implementations, as schematically illustrated by FIGS. 9B and 9C, the at least one coupler 30 can comprise a radial bearing swivel 92 (e.g., radial yoke; spherical bearing) configured to allow an orientation of the vehicle 10 relative to the rail 20 and/or the earth to be controllably adjusted. For example, as the vehicle 10 experiences various forces (e.g., from banking into a turn; from side and/or head winds) that cause the vehicle 10 to pitch, yaw, and/or roll, the radial bearing swivel 92 can be configured to compensate for unwanted motion of the vehicle 10.

In certain such implementations, as schematically illustrated by FIG. 9B, the stabilization system 90 comprises at least one gyroscope 94 configured to produce a counteracting force on the vehicle 10 to reduce (e.g., dampen; eliminate) the magnitude of the unwanted motion of the vehicle 10, thereby stabilizing the vehicle 10. In certain other such implementations, as schematically illustrated by FIG. 9C, the stabilization system 90 comprises at least one tuned mass damper 96 configured to adjust a resonant frequency of the vehicle 10 to reduce (e.g., dampen; eliminate) the magnitude of the unwanted motion of the vehicle 10, thereby stabilizing the vehicle 10. The at least one gyroscope 94 and/or the at least one tuned mass damper 96 can be positioned in a portion of the vehicle 10 spaced away from the coupler 30 (e.g., in a lower portion of the vehicle 10 as shown in FIGS. 9B and 9C; in an upper portion of the vehicle 10 on an undercarriage maglev system) to counter rotational forces about the coupler 30. In certain implementations, the at least one gyroscope 94 and/or the at least one tuned mass damper 96 is configured to be used to move, slow, brake, or stop the vehicle 10 in an emergency situation.

In certain implementations, the stabilization system 90 further comprises at least one shock absorber configured to inhibit vibrations of the vehicle 10 while travelling along the magnetic rail system 5 (e.g., to reduce vibrations while traveling at high speeds along the magnetic rail system 5). The at least one shock absorber can comprise one or more hydraulic cylinders, springs, and/or magnetic or non-magnetic struts built into the at least one coupler 30. The at least one shock absorber of certain implementations can also absorb small impacts or vibrations resulting from the vehicle 10 entering or exiting the magnetic rail system 5.

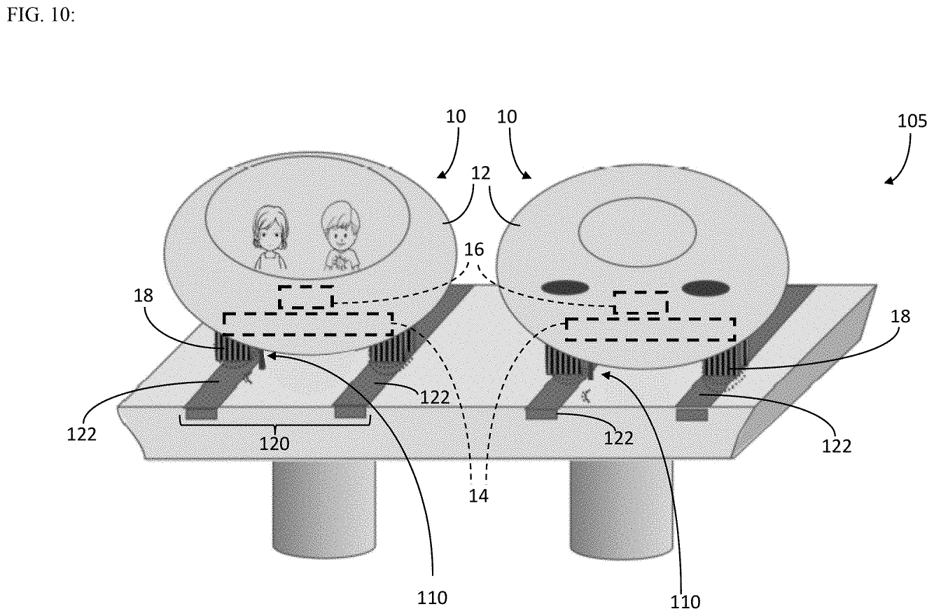

FIGS. 10, 11A-11B, and 12A-12B schematically illustrate various example vehicles 10 and example magnetic rail systems 5 (e.g., undercarriage maglev systems 105) beneath the vehicles 10 in accordance with certain implementations described herein. The vehicle 10 can comprise a body 12 configured to contain at least one passenger and/or cargo. The vehicle 10 can further comprise an engine 14, a drivetrain 16, and a plurality of wheels 18 in mechanical communication with the body 12 and configured to propel the body 12 along road surfaces. The vehicle 10 can further comprise at least one magnetic levitation interface 110 (e.g., coupler) in mechanical communication with a lower portion (e.g., affixed to an underside) of the body 12, the at least one magnetic levitation interface 110 configured to controllably and repeatedly engage with and be propelled along a magnetic track 120 below the body 12 and to controllably and repeatedly disengage from the magnetic track 120. The vehicle 10 can be above the magnetic track 120 and configured to be propelled along the magnetic track 120. In certain implementations, the magnetic track 120 can comprise at least one rail 122 or sheet (e.g., aluminum) that is incorporated into or beneath road surfaces and the undercarriage of the vehicle 10 can comprise the maglev components. By having the vehicle 10 compatible with traveling along the undercarriage maglev system 105 and conventional road surfaces, the vehicle 10 can be configured to drop off passengers at a location and then can autonomously travel to a parking area.

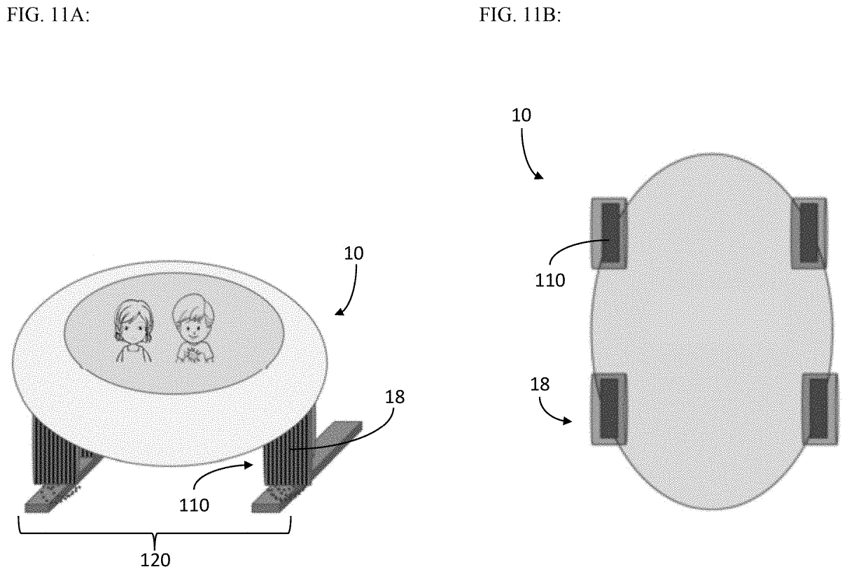

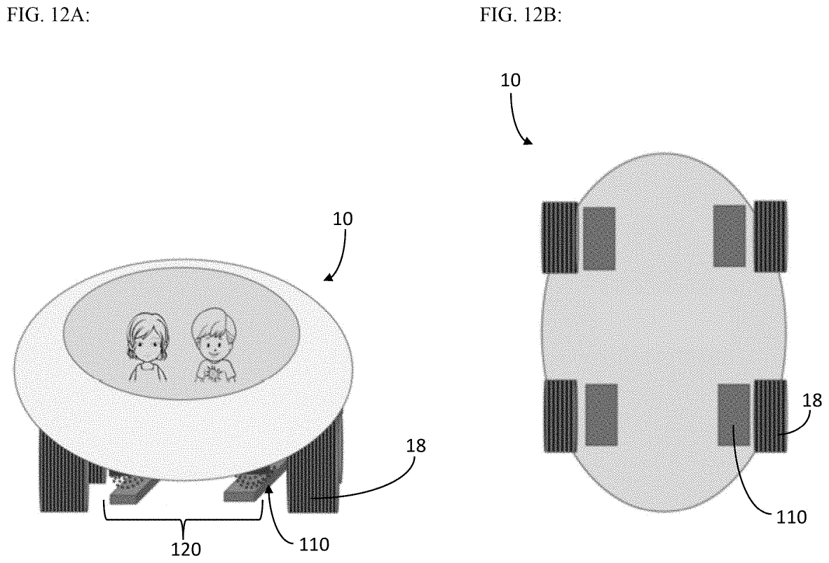

FIG. 10 schematically illustrates two example vehicles 10 travelling in substantially opposite directions along two magnetic tracks 120 that are substantially parallel to one another in accordance with certain implementations described herein. In certain implementations (see, e.g., FIG. 10), each magnetic track 120 comprises two substantially parallel rails 122, each rail 122 beneath two wheels 18 of the vehicle 10, while in certain other implementations, each magnetic track 120 comprises a single rail 122. FIGS. 11A and 11B schematically illustrate a front view and bottom view, respectively, of an example vehicle 10 comprising a plurality of magnetic levitation interfaces 110 that are part of at least one wheel rim of at least one wheel 18 in accordance with certain implementations described herein. For example, the wheel rims can comprise aluminum and can be configured to interact with magnetic fields generated by the rails 122 underneath the wheel rims. The wheel rims can be used to magnetically drive the vehicle 10 along the undercarriage magnetic system 105 as well as to hold the tires of the wheels 18 for traveling along road surfaces. FIGS. 12A and 12B schematically illustrate a front view and bottom view, respectively, of an example vehicle 10 comprising a plurality of magnetic levitation interfaces 110 that are affixed to an underside of the vehicle 10 in accordance with certain implementations described herein. For example, the body 12 can comprise a chassis and the at least one magnetic levitation interface 110 can be fixedly attached to the chassis and can be configured to interact with magnetic fields generated by the rails 122 underneath the chassis.

The undercarriage maglev system 105 of certain implementations can utilize a battery recharging system comprising magnetic induction coils and/or electrical conductors, as described herein with regard to the elevated magnetic rail system 5. The vehicle 10 compatible with the undercarriage maglev system 105 of certain implementations can utilize at least one communication device 60 in communication with a central communication system (e.g., GAN) as described herein with regard to the coupler 30 for the elevated magnetic rail system 5. The vehicle 10 compatible with the undercarriage maglev system 105 of certain implementations can utilize an extension/retraction system configured to controllably extend and retract the at least one magnetic levitation interface 110, as described herein with regard to the coupler 30 for the elevated magnetic rail system 5. For example, for increased ground clearance, the at least one magnetic levitation interface 110 can be retracted into the body 12 to avoid obstacles along road surfaces. The vehicle 10 compatible with the undercarriage maglev system 105 of certain implementations can utilize a stabilization system 90 as described herein with regard to the vehicle 10 traveling along the elevated magnetic rail system 5.

In certain implementations, the vehicle 10 comprises both at least one coupler 30 and at least one magnetic levitation interface 110 and is configured to travel along an elevated magnetic rail system 5 and/or an undercarriage maglev system 105. For example, an undercarriage maglev system 105 can be utilized in less populated areas and an elevated magnetic rail system 5 can be utilized in more structurally dense areas (e.g., New York boroughs), and the vehicle 10 can be compatible with both to maximize usage in rural and urban areas.

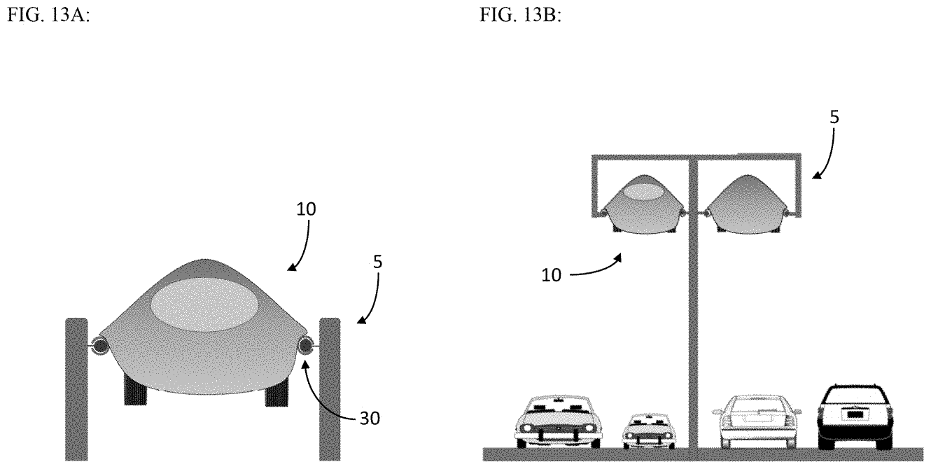

FIGS. 13A and 13B schematically illustrate two view of another example vehicle 10 and an example magnetic rail system 5 in accordance with certain implementations described herein. In certain implementations, the at least one coupler 30 (e.g., magnetic levitation interface 110) is on at least one lateral side of the vehicle 10 and is configured to interact with the magnetic rail system 5 extending along the at least one lateral side. For example, as shown in FIG. 13A, at least two couplers 30 are on opposite sides of the vehicle 10 and are configured to hold the vehicle 10 on two magnetic rails of the magnetic rail system 5. As shown in FIG. 13B, the magnetic rail system 5 and the vehicles 10 can be elevated relative to a road surface on which other vehicles (e.g., conventional vehicles and/or vehicles 10).

### Example Magnetic Rail Systems

The magnetic rail system 5 of certain implementation is compatible with at least one of the vehicles 10 described herein. In certain implementations, the magnetic rail system 5 provides at least one of the following: battery power charging to the vehicles 10 traveling along the rails 20; sensor network; structural health monitoring system; safety devices to move vehicles 10 off the rails 20 in the event of damage, collisions, or power loss; a central communication system (e.g., GAN) configured to autonomously control the vehicles 10 engaged with (e.g., travelling along) the magnetic rail system 5. The magnetic rail system 5, including any local rail-entry-exit capture portions configured to engage the vehicles 10 can all have set, standardized dimensions, magnetic qualities, infrastructural compatibility, and other values to allow vehicles 10 from different vehicle manufacturers to utilize the magnetic rail system 5 with complete safety. The magnetic fields 42 between the vehicles 10 and the magnetic rail system 5 that levitate and propel the vehicles 10 can be produced by the rails 20, by the at least one coupler 30, by the undercarriage maglev system 105, or a combination thereof. As the vehicle 10 pulls into an entry station, the coupler 30 or magnetic levitation interface 110 can engage the magnetic rail system 5 or undercarriage maglev system 105 where at least some of the magnetic fields 42 elevate the vehicle 10, and at least some of the magnetic fields 42 propel the vehicle 10 forward or stop the vehicle 10 when required.

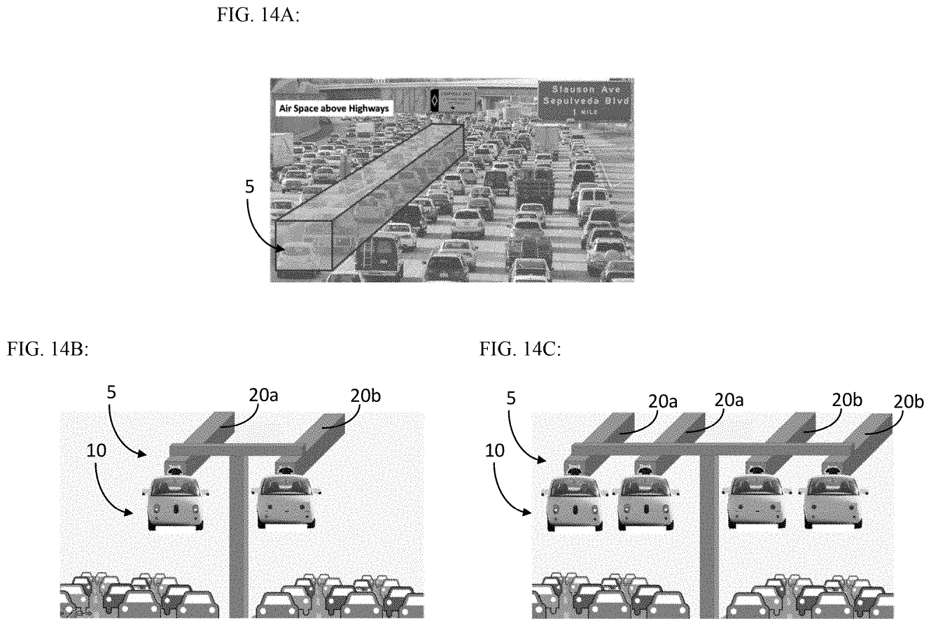

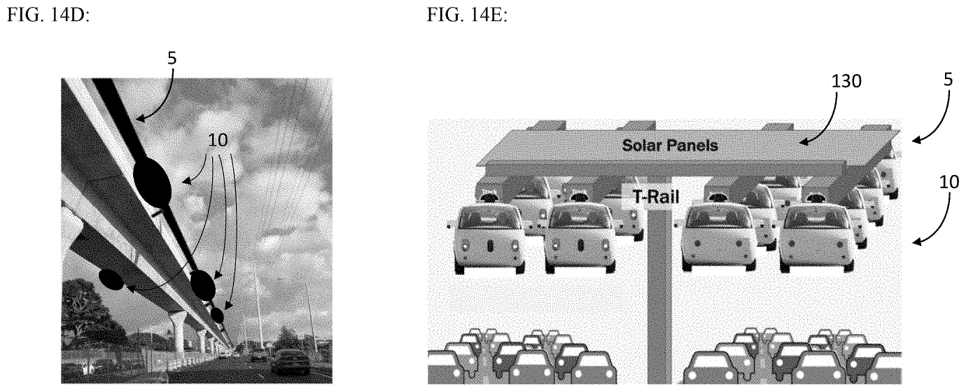

In certain implementations, at least portions of the magnetic rail system 5 are configured to follow road surfaces (e.g., highways) along which other vehicles (e.g., conventional vehicles; vehicles 10 as described herein) can travel. FIGS. 14A-14E schematically illustrate example magnetic rail systems 5 in accordance with certain implementations described herein. While FIGS. 14A-14E schematically illustrate examples of elevated magnetic rail systems 5, other types of magnetic rail systems 5 can also be used (e.g., undercarriage maglev system 105, which can be adapted to handle vehicles 10 with larger weights than vehicles 10 for an elevated magnetic rail system 5).

At least portions of the magnetic rail system 5 can be located in air space above a highway (e.g., see FIG. 14A) and can comprise multiple rails 20. For example, as shown in FIG. 14B, the magnetic rail system 5 can comprise a first rail 20a along which vehicles 10 are traveling in a first direction and a second rail 20b along which vehicles 10 are traveling in a second direction substantially opposite to the first direction. As shown in FIG. 14C, the magnetic rail system 5 can comprise two or more first rails 20a along which vehicles 10 are traveling in a first direction and two or more second rails 20b along which vehicles 10 are traveling in a second direction substantially opposite to the first direction. In certain implementations, as shown in FIG. 14D, the magnetic rail system 5 can be attached or mounted to an existing structure (e.g., an elevated rail track, viaduct, bridge, railroad space), while in certain other implementations, the magnetic rail system 5 can be a standalone independent rail system (e.g., located in the center of a highway). In certain implementations, the magnetic rail system 5 comprises at least one renewable or environmentally friendly power source 130 (e.g., solar power; wind power) configured to provide power to the magnetic rail system 5. For example, as shown in FIG. 14E, the power source 130 can comprise solar panels mounted on surface above the rails 20 and the vehicles 10, the solar panels configured to provide power to the magnetic rail system 5.

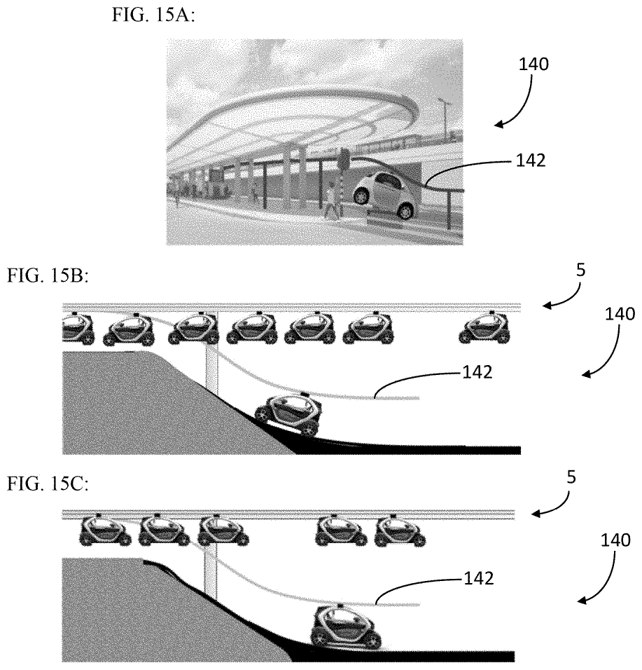

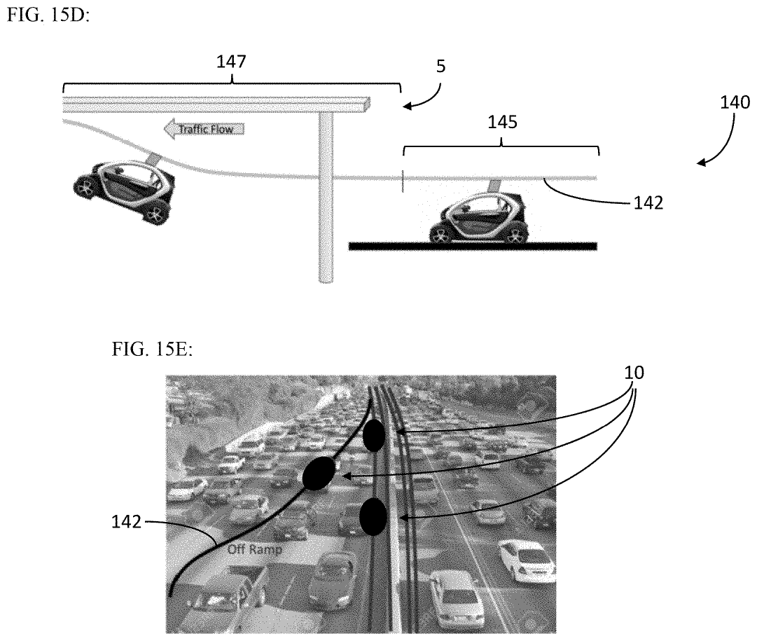

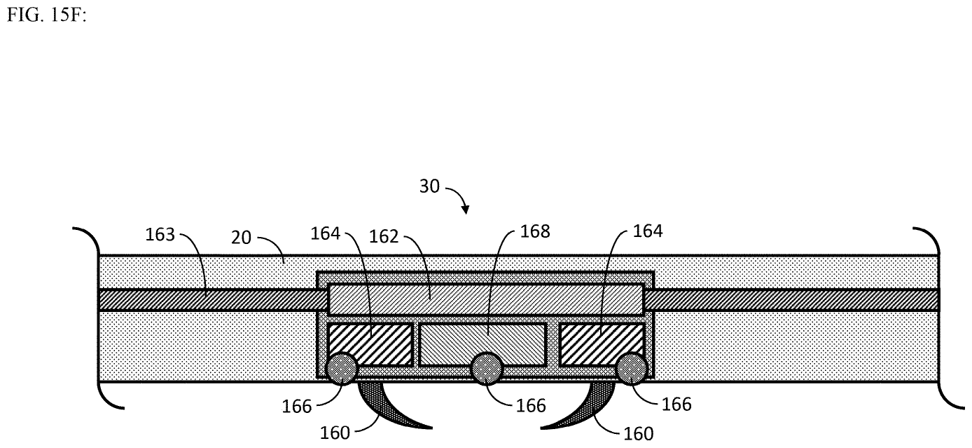

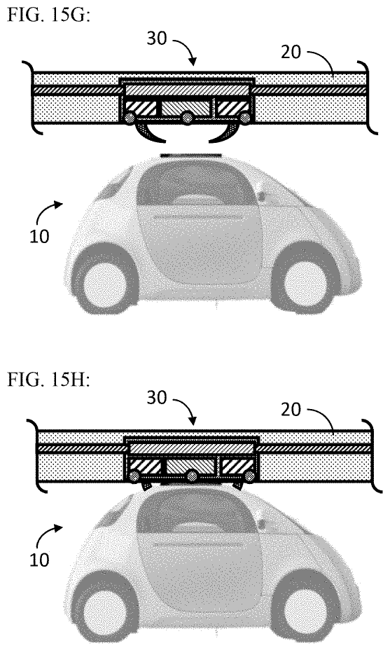

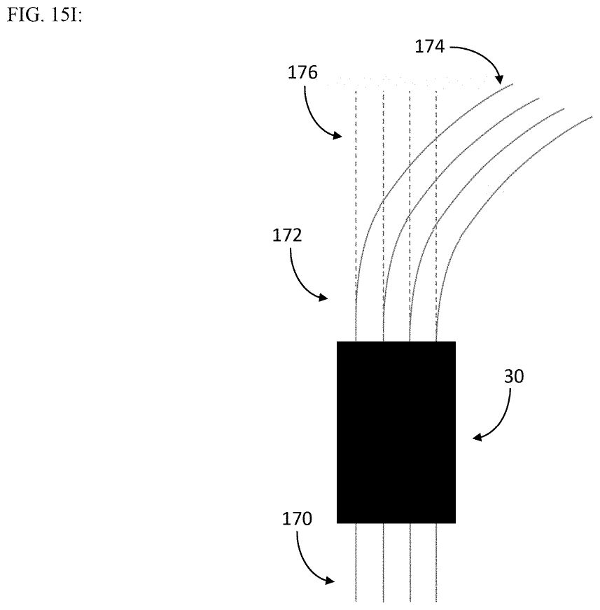

In certain implementations, the magnetic rail system 5 comprises a plurality of entry/exit stations 140 configured to facilitate vehicles 10 engaging with the magnetic rail system 5 and disengaging from the magnetic rail system 5. The entry/exit stations 140 of certain implementations can be at different locations that are near predetermined destinations (e.g., urban neighborhood; office building; shopping mall; entry/exit of highway system). FIGS. 15A-15E schematically illustrate examples of entry/exit stations 140 compatible with certain implementations described herein. In certain implementations, an entry/exit station 140 comprise at least one entry/exit ramp 142 comprising a rail 20 configured to facilitate engagement/disengagement of the vehicles 10 to/from the magnetic rail system 5. The entry/exit ramp 142 can be configured to facilitate entry and/or exit of vehicles 10 onto the magnetic rail system 5 from/to road surfaces. For example, as schematically illustrated by FIGS. 15B and 15D, the entry/exit ramp 142 comprises an entry lane along which vehicles 10 can begin traveling at a first speed (e.g., relatively low speed) from a road surface and can accelerate while traveling along the entry lane to a second speed (e.g., relatively high speed; speed substantially equal to the speed of vehicles 10 traveling along the rails 20 of the magnetic rail system 5), the second speed higher than the first speed, to merge with the other vehicles 10 traveling along the rails 20. For another example, as schematically illustrated by FIGS. 15A and 15C, the entry/exit ramp 142 comprises an exit lane along which vehicles 10 can separate from the other vehicles 10 traveling along the rails 20 and can begin traveling at a third speed (e.g., relatively high speed; speed substantially equal to the speed of vehicles 10 traveling along the rails 20 of the magnetic rail system 5) and can decelerate while traveling along the exit lane to a fourth speed (e.g., relatively low speed), the fourth speed lower than the third speed, such that the vehicles 10 can propel themselves along road surfaces. In certain implementations, the entry/exit ramp 142 comprises at least one rail switch (e.g., mechanical switch; electromechanical switch) configured to move vehicles 10 on/off a main rail 20 of the magnetic rail system 5.

In certain implementations, the entry/exit ramp 142 comprises a plurality of stages along which the vehicles 10 travel at different speeds. For example, as shown in FIG. 15D, an entry lane can comprise a first stage 145 and a second stage 167 coupled to the magnetic rail system 5 and to the first stage 145. Along the first stage 145, vehicles 10 travel under their own propulsion (e.g., using the engine 14, drivetrain 16, and wheels 18) at a slow speed (e.g., less than 20 miles per hour) and accelerate to the second stage 147. At the second stage 147, the vehicles 10 engage and are propelled by a passive maglev propulsion system of the magnetic rail system 5 (e.g., without being propelled under their own propulsion) onto the magnetic rail system 5. In certain implementations, the vehicle 10 can use its own wheels 18 and a running platform under the rails 20 until the vehicle 10 achieves a speed at which passive magnetic levitation occurs. FIG. 15E schematically illustrates an entry/exit ramp 142 comprising an exit lane extending over a highway in accordance with certain implementations described herein. The exit lane can comprise a third stage coupled to the magnetic rail system 5 and a fourth stage coupled to the third stage. Along the third stage, vehicles 10 are propelled by the passive maglev propulsion system of the magnetic rail system 5 (e.g., without vehicles 10 being propelled under their own propulsion) and decelerate to the fourth stage. At the fourth stage, the vehicles 10 travel under their own propulsion (e.g., using the engine 14, drivetrain 16, and wheels 18) at a slow speed (e.g., less than 20 miles per hour) to the highway road surface.

In certain implementations, the entry/exit ramp 142 comprises a safety system comprising at least one sensor configured to detect information from the vehicles 10 and a safety gating means (e.g., switch) to allow or not allow entry by the vehicles 10 onto the magnetic rail system 5. The magnetic rail system 5 can comprise a controller (e.g., GAN controller) configured to respond to data signals from the at least one sensor, the data signals indicative of a vehicle's safety, and in response, to generate signals to the safety gating means to allow or not allow entry by the vehicle 10 onto the magnetic rail system 5. For example, the sensor data signals can be generated by a hazardous material sniffer sensor and can alert the controller to prohibit entry to the magnetic rail system 5 by vehicles 10 containing hazardous materials. For another example, the sensor data signals can be generated by a weight sensor and can alert the controller to prohibit entry to the magnetic rail system 5 by vehicles 10 having an axial weight greater than an acceptable amount in view of the mechanical status or fitness for operation of the magnetic rail system 5.

In certain implementations, the entry/exit station 140 comprises an alignment system configured to facilitate alignment of the coupler 30 with the rail 20 of the magnetic rail system 5 (e.g., to prevent damage to the vehicle 10 and/or the rail 20 during engagement/disengagement). The alignment system can comprise at least one sensor (e.g., optical sensor; magnetic sensor; Hall Effect proximity sensor; LiDAR sensor) configured to detect a position and/or orientation of the coupler 30 relative to the rail 20 (e.g., to ensure that an approaching vehicle 10 is configured to correctly engage the rail 20). For example, the alignment system can comprise a laser on the vehicle 10 and a laser reader on the entrance portion of the rail 20 configured to autonomously and wirelessly control/drive/align the vehicle 10 to the rail 20. Alignment of certain implementations can be accomplished non-autonomously as well (e.g., a bumper/guide that align the wheels 18 to the correct position such that the vehicle 10 and coupler 30 are in the correct position for engagement of the rail 20; side-to-side movement of the coupler 30 and configured to be nudged into the slot 22 of the rail 20). The entrance/exit portions of the rails 20 and the coupler 30 can have standardized dimensions, materials, and characteristics, thereby allowing vehicles 10 from different manufacturers to fit onto the magnetic rail system 5.

FIG. 15F schematically illustrates a side view of an example coupler 30 (e.g., maglev unit) configured to be controllably and repeatedly attachable to and detachable from a vehicle 10 and/or a shipping container while the coupler 30 remains on the rail 20 in accordance with certain implementations described herein. For example, the coupler 30 can be considered to be a shuttle that remain on the rails 20 and is configured to be controllably and repeatedly attached to and detached from the vehicle and/or shipping container. The coupler 30 comprises at least one magnetic levitation propulsion subsystem configured to propel the coupler 30 along the magnetic levitation rail system via magnetic levitation.

In certain implementations, the coupler 30 further comprises at least one connector 160 (e.g., a pair of mechanical grips; pincer grips; clamps; Androgynous Peripheral Attach System (APAS); Androgynous Peripheral Assembly System (APAS); Androgynous Peripheral Docking System (APDS) such as those used on space stations; twist lock-type connectors such as those used on ISO shipping containers) configured to controllably and repeatedly latch onto the vehicle 10 and/or the shipping container and controllably and repeatedly detach from the vehicle 10 and/or shipping container. The coupler 30 further comprises at least one electrical conductor 162 (e.g., copper; two-dimensional electrically conductive material; room temperature superconductor) configured to be in electrical communication with an electrical power grid 163 of the magnetic rail system 5. The coupler 30 further comprises at least one battery 164 (e.g., lithium ion battery) configured to receive and store power from the electrical power grid 163 via the at least one electrical conductor 162. The coupler 30 further comprises a plurality of wheels 166 configured to be in mechanical communication with the magnetic rail system (e.g., the wheels 166 in contact with the rail 20 and configured to be used if power is lost to the coupler 30). The coupler 30 further comprises a motor subsystem 168 (e.g., comprising at least one motor and stabilization controls) in mechanical communication with the plurality of wheels 166. The motor subsystem 168 is configured to drive the wheels 166 to propel the vehicle 10 and/or shipping container (e.g., while attached to the coupler 30) along the magnetic rail system 5 (e.g., along the rail 20). For example, the wheels 166 and the motor subsystem 168 can be configured to accelerate the coupler 30 (e.g., maglev unit) to passive magnetic take-off speeds at which magnetic levitation of the coupler 30 is activated. For another example, in the event of loss of magnetic levitation and/or power on the electrical power grid 163 of the rail 20 (e.g., loss of external power to the coupler 30), the wheels 166 and the motor subsystem 168 can be configured to be controllably activated to propel the coupler 30 along the rail 20 using power received from the at least one battery 164 (e.g., to move the coupler 30 to an exit station and/or off-ramp 142).

FIG. 15G schematically illustrates a side view of the coupler 30 of FIG. 15F prior to being attached to a vehicle 10 and/or subsequent to being detached from the vehicle 10 in accordance with certain implementations described herein. FIG. 15H schematically illustrates a side view of the coupler 30 of FIG. 15F attached to the vehicle 10 in accordance with certain implementations described herein.

In certain implementations, the coupler 30 (e.g., maglev unit) further comprises a maglev motor (not shown) configured to use magnetic levitation to propel the coupler 30 along the rail 20. For example, the maglev motor can comprise a tubular motor comprising a first tube extending within a second tube (e.g., one of the first tube and the second tube being a component of the rail 20), at least one of the first and second tubes comprising at least one two-dimensional room temperature superconducting magnetic material (e.g., graphene). The first and second tubes can provide both the magnetic levitation and propulsion by having one of the first and second tubes act as a magnetic coil and the other of the first and second tubes act as a magnet. Graphene-based or similar two-dimensional material maglev systems can provide similar or higher levitation forces than do other superconducting maglev systems, while being lighter and more cost-effective.

Other example two-dimensional room temperature superconducting magnetic materials having sufficient electrical conductivity and mechanical strength compatible with certain implementations described herein include but are not limited to: graphyne; germanene; silicene; stanine; phosphorene; plumbene. Bismuthene is a topological insulator that can be used in conjunction with one or more of the two-dimensional room temperature superconducting magnetic materials. In certain implementations, the at least one two-dimensional room temperature superconducting magnetic material can comprise a single layer or multiple layers or nanoplatelets (e.g., having sufficient thicknesses). For example, the two-dimensional magnetic material can comprise a single layer or multiple layers of carbon atoms bonded together with sp2 bonds in a hexagonal lattice pattern (e.g., graphene). The at least one two-dimensional room temperature superconducting magnetic material can be applied to an underlying substrate (e.g., concrete; metal; portion of the rail 20) using vapor deposition or another application methodology and can have a pattern of various north/south magnetic configurations (e.g., Halbach array) to act as a track to produce magnetic fields.

In certain implementations, maglev steering technology with two-dimensional materials can be used to move the coupler 30 from a high speed lane to an off ramp (e.g., having a two-dimensional material laid out in a specific pattern, such as a fork in the road/guideway). FIG. 15I schematically illustrates a top view of a coupler 30 (e.g., shuttle) traveling along magnetically activated linear track portions 170 in accordance with certain implementations described herein. The coupler 30 is shown in FIG. 15I to be approaching a track fork 172 comprising magnetically activated curved track portions 174 (denoted by solid lines) and magnetically inactive linear track portions 176 (denoted by dashed lines). These electrically activated track patterns can be controlled by the GAN to move a coupler 30 on or off main track portions (e.g., of an elevated magnetic rail system) to secondary track portions. These linear track patterns can be used in a combination with shuttle-based magnets or magnetic fields.

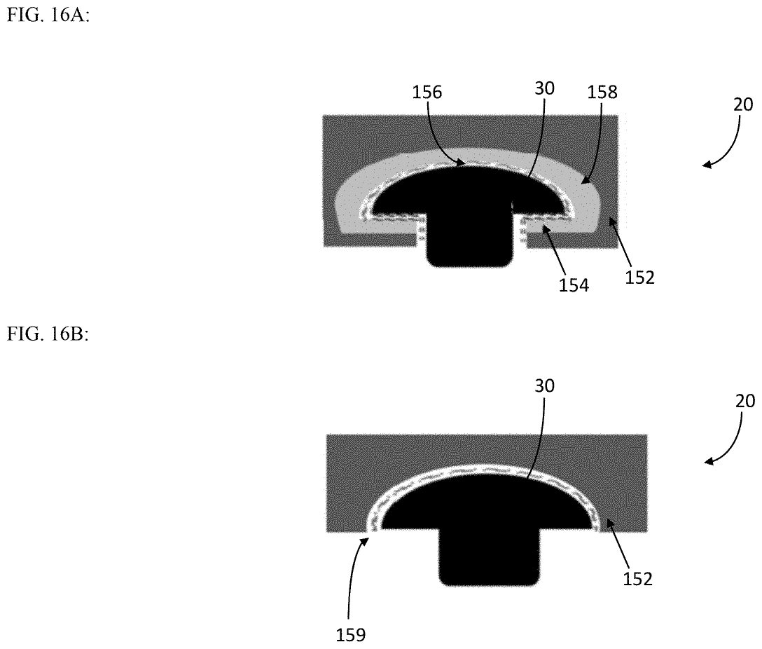

FIGS. 16A and 16B schematically illustrate views along the longitudinal axis 21 of two example rails 20 of an entry lane of an entry/exit ramp 142 in accordance with certain implementations described herein. The rail 20 comprises a first rail portion 152 (e.g., first track portion) configured to controllably engage with a coupler 30 (e.g., capture arm) extending from a vehicle 10 below the first rail portion 152. The rail 20 can further comprise a second rail portion 154 (e.g., second track portion) configured to receive the coupler 30 from the first rail portion 152 and to have the vehicle 10 travel along the at least one second rail portion 154. The second rail portion 154 (not shown in FIG. 16B) comprises a slot 156 configured to receive the coupler 30 from the first rail portion 152. The slot 156 of the second rail portion 154 can be the slot 22 of the rails 20 that comprise a majority of the rails 20 of the magnetic rail system 5. In the examples of FIGS. 16A and 16B, the coupler 30 and the slot 156 of the second rail portion 154 each have a substantially T-shaped cross section.

As shown in FIG. 16A, the first rail portion 152 of certain implementations comprises an entrance slot 158 configured to receive the coupler 30 and that is substantially T-shaped and has a flared cross-section. At a first end portion of the rail 20, the entrance slot 158 can have a first size substantially larger than a size of the coupler 30 and at a second portion of the rail 20 spaced from the first end portion along the longitudinal axis 21, the entrance slot 158 can have a second size smaller than the first size. For example, as the vehicle 10 pulls into the entry/exit station 140, the coupler 30 is initially disengaged from the rail 20 and can engage (e.g., slide into) the entrance slot 158 at the first end portion of the rail 20. As the vehicle 10 travels along the rail 20, the portion of the entrance slot 158 engaging the coupler 30 becomes smaller, until the coupler 30 reaches the slot 156 of the second rail portion 154.

As shown in FIG. 16B, the first rail portion 152 of certain implementations comprises an entrance recess 159 configured to lift the coupler 30 by magnetic force and to receive the coupler 30. For example, as the vehicle 10 pulls into the entry/exit station 140, the coupler 30 on top of the vehicle 10 enters into the entrance recess 159 where a magnetic field (e.g., produced by the vehicle 10 and/or the rail 20) elevates the vehicle 10. As the vehicle 10 travels forward along the rail 20 (e.g., is magnetically propelled) from the first rail portion 152 to the second rail portion 154, the coupler 30 engages the slot 156 of the second rail portion 154.

In certain implementations, an exit lane of an entry/exit ramp 142 in accordance with certain implementations described herein comprises a third rail portion (e.g., third track portion) comprising a slot configured to receive the coupler 30 from the slot 22 (e.g., the slot 156 of the second rail portion 156), the third track portion configured to controllably disengage from the coupler 30. For example, analogous to the entrance slot 158 of FIG. 16A, the third rail portion can comprise an exit slot that is substantially T-shaped with a flared cross-section and is configured to disengage from the coupler 30. For another example, analogous to the entrance recess 159 of FIG. 16B, the third rail portion can comprise an exit recess configured to lower the coupler 30 by magnetic force

In certain implementations, the magnetic rail system 5 comprises a structural health monitoring (SHM) system configured to monitor the operation and structural integrity of the vehicles 10, rails 20, and support structures. The SHM system can be in operative communication with a central communication (e.g., GAN) system of the magnetic rail system 5. The SHM system can comprise a fiber optic communications and sensor network having a plurality of sensors at various locations which provide feedback signals to open-loop and/or closed-loop sensor networks. Example sensors include but are not limited to: cameras or other optical sensors (e.g., LiDAR to measure distances); wind speed sensors; acoustic/seismic sensors configured to detect impact forces to the magnetic rail system 5; tilt sensors configured to detect tilt of portions of the magnetic rail system 5 dues to ground settling or superstorm events; fiber optic sensors configured to sense stress due to loose or vibrating maglev magnetics components; magnetic sensor configured to sense drift of the magnetic flux of maglev magnetic components. In other examples, a spare fiber of a fiber optic (FO) communication cable (e.g., in a cable bundler attached to the cable through the cable jacket) can be used as a strain gauge (e.g., as a distributed fiber strain gauge) or as a temperature sensor (e.g., used for temperature measurement and strain gauge compensation, which can increase the sensitivity of the strain measurement to several units of micro strain). In certain implementations, if wind gusts cause the strain measurement to change in a specific location, the SHM system can provide signals to be used by the GAN system to control the gyroscopes of a vehicle 10 to stabilize the vehicle 10.

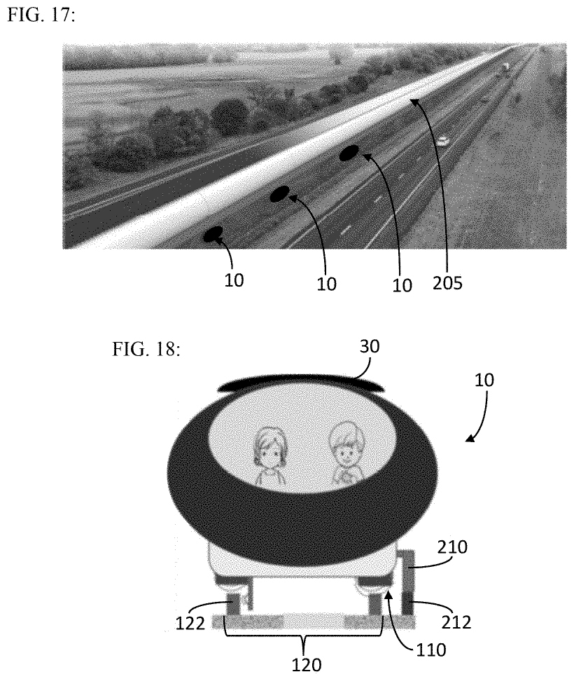

In certain implementations, the magnetic rail system 5 and/or the vehicles 10 are configured to interface with other types of transportation systems (e.g., vactrain or hyperloop; railroad; underwater; underground tunnel). For example, the coupler 30 of certain such implementations can be configured to transition from an overhead magnetic lift configuration configured to interface with the magnetic rail system 5 to another configuration compatible with interfacing with another transportation system. FIG. 17 schematically illustrates a plurality of vehicles 10 traveling along a magnetic rail system 5 coupled to an outside portion of a vacuum tube train (“vactrain”) system 205 in accordance with certain implementations described herein. This configuration can maximize land usage and can increase commuter throughput by multiple times. In certain other implementations, the vehicles 10 are configured to travel within the vactrain system 205. For example, the vehicle 10 can be made in a capsule shape from light weight composites and can be configured to withstand the vacuum conditions of the vactrain system and to function on a vactrain track by means of a vacuum-pressure-proof fuselage. The vehicle 10 can include safety features for traveling along the magnetic rail system 5, the vactrain system 205, and on road surfaces using the wheels 18.

FIG. 18 schematically illustrates a vehicle 10 comprising a coupler 30 compatible for interfacing with an elevated magnetic rail system 5 and a magnetic levitation interface 110 compatible for interfacing with railroad rails 122 in accordance with certain implementations described herein. The railroad rails can be used as the magnetic track 120 with the magnetic levitation interface 110 to serve as an undercarriage maglev system 105. As with FIGS. 10, 11A-11B and 12A-12B, each magnetic track 120 can comprise two substantially parallel rails 122 and the magnetic levitation interfaces 110 can be part of the wheel rims or can be affixed to an underside of the vehicle 10. In certain implementations, the vehicle 10 comprises an electrical battery (not shown) and a battery recharging system comprising an electrically conductive adapter arm 210 configured to be in electrical communication with a third rail 212 configured to provide electrical power to the vehicle 10. In certain implementations, the vehicle 10 is configured to be mechanically coupled to a sled-like device to allow normal or high speed railroad (HSR) access. The vehicle 10 can pull into a train station and autonomously mount itself to a high speed rail adapter such that the vehicle 10 can travel along railroad rails, thereby allowing for maximum utilization of the underutilized railroad system and/or future vactrain systems.

In certain implementations, the magnetic rail system 5 comprises a monitoring system configured to monitor operation of the magnetic rail system 5 and/or the vehicles 10. For example, the vehicle 10 can comprise a sensing system configured to detect and record whether the vehicle 10 has been in a collision or accident on a roadway separate from the magnetic rail system 5 (e.g., off the rails 20) and to transmit a vehicle fitness report to a centralized controller (e.g., GAN network) to evaluate for service inspection before the vehicle 10 is permitted to enter the magnetic rail system 5. In certain implementations, the vehicle 10 can be deactivated/shutdown after an accident, thereby forcing the vehicle owner to return the vehicle 10 to a certified repair facility for inspection and repair. In certain implementations, various sensors (e.g., cameras; radar sensors; lidar sensors) can be used to avoid collisions between the vehicles 10 and other objects on or near the rails 20 (e.g., large trucks on the nearby road; persons on the rails 20), and the GAN network can adjust the velocities of vehicles 10 behind the point of impact accordingly. High energy impacts (e.g., by trucks) into the magnetic rail system 5 or the superstructure can be measured by sensors (e.g., fiber optic accelerometers) built into critical high-risk areas of the magnetic rail system 5. Distributed fiber optic strain gauges can also be built into the magnetic rail system 5 to detect ground shifting, movement, or impacts where accelerometers are not present.

In certain implementations, the magnetic rail system 5 comprises a maintenance system configured to maintain the operable condition of the magnetic rail system 5. For example, the magnetic rail system 5 can comprise a magnetic head cleaner configured to be placed at selected locations along the magnetic rail system 5 (e.g., at the entry/exit stations) to clean the magnetic side of the coupler 30 or magnetic levitation interfaces 110. An autonomous (e.g., self-cleaning) mechanism can travel along the rails 20 to keep the rails 20 (e.g., magnetic components) free of particles and foreign objects. The autonomous mechanism can also paint certain components during off-peak hours.

In certain implementations, the magnetic rail system 5 comprises an inspection system configured to inspect the rails 20 of the magnetic rail system 5. For example, the magnetic rail system 5 can comprise an autonomous robot comprising at least one sensor (e.g., fiber optic sensors; electrical sensors; ring laser gyroscopes to measure very small movements or looseness of the rails, piers, or other structural components). The at least one sensor can comprise an eddy current sensor configured to detect cracking in metal components. In certain implementations, the magnetic rail system 5 can be used as an autonomous eddy current sensor to take eddy current measurements of the rails 20 during off-peak hours.

The robot of certain implementations is configured to travel along the magnetic rail system 5 (e.g., on a regular or scheduled timetable) and to report SHM information to a central controller (e.g., GAN network) of the magnetic rail system 5. Examples of conditions to be reported by the robot include, but are not limited to: shifts, vibrations, or other movements of the rails, vibration wear, acceleration and deceleration, speed decrease, and communication. The robot can also be heavier than a vehicle 10 to overstress the rails 20 to test the rail's structural integrity. The robot can be configured to determine whether maintenance crews are to be requested to inspect further or provide repairs. The robot can be configured to create a wobble in the rail (e.g., using an off-axis fly wheel or some other device) which can be measured by sensors in other locations of the magnetic rail system 5 to check the health of the maglev fields. In certain implementations, the monitoring system is configured to monitor the attachments of the magnetic rail system 5 to other superstructures (e.g., elevated light rail bridge; vactrain). In certain other implementations, the maintenance sensors can be mounted in the vehicles 10 and configured to report rail and vehicle conditions in real-time back to the GAN network. If a rail segment is unsafe, the GAN network can reroute or detour traffic of vehicles 10 to a safer route. The highly accurate, automated, 24/7 monitoring and daily inspection by robots of certain implementations can greatly reduce the manual human inspection as compared to normal bridges and structures and can allow preemptive repair plans during off-peak hours.

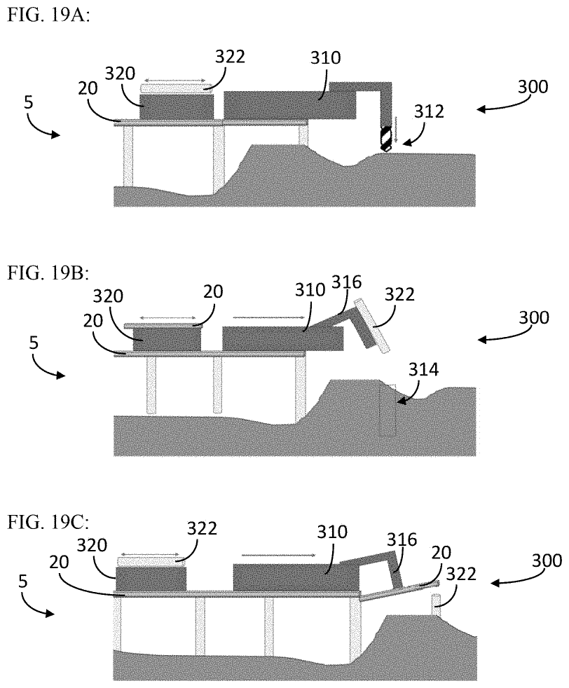

FIGS. 19A-19C schematically illustrate a series of example steps performed by an example construction system 300 configured to lay rails 20 of an example magnetic rail system 5 in accordance with certain implementations described herein. In certain implementations, the construction system 300 is automated and can be configured to support rapid and ecological installation of the magnetic rail system 5 (e.g., in middle of a desert; in the center of a major highway or other existing infrastructure). The construction system 300 of certain implementations can operate 24/7, thereby reducing the carbon foot print and construction labor cost to a fraction of traditional construction. When constructing the magnetic rail system 5 in different areas and/or coupled to different existing infrastructure, the automated construction system 300 can use different fabrication processes to adapt to these different areas and/or conditions, although the material shuttling, drilling or pipe driving or boring, rail erection, in these different areas and/or conditions can still be done from the rail as described herein.

In certain implementations, the construction system 300 is positioned on a previously-constructed portion of the magnetic rail system 5 and comprises a construction train 310 and a shuttle 320 configured to provide construction materials to the construction train 310. Both the construction train 310 and the shuttle 320 are configured to travel along the rails 20 of the magnetic rail system 5. By operating on the rails 20, the shuttle 320 can reduce lane closures and truck traffic that supply construction materials to the construction train 310, thereby reducing the installation costs. As shown in FIG. 19A, the construction system 300 can comprise a drill 312 configured to bore holes 314 into the earth and the shuttle 320 can be configured to transport construction materials, such as support structures 322 (e.g., pylons; piers) and rail portions 20, to the construction train 310. As shown in FIG. 19B, the construction train 310 can further comprise at least one placement arm 316 configured to move and insert support structures 322 into the drilled holes 314. As shown in FIG. 19C, the at least one placement arm 316 can be further configured to move and place rail portions 20 onto the support structures 322, thereby extending the magnetic rail system 5.

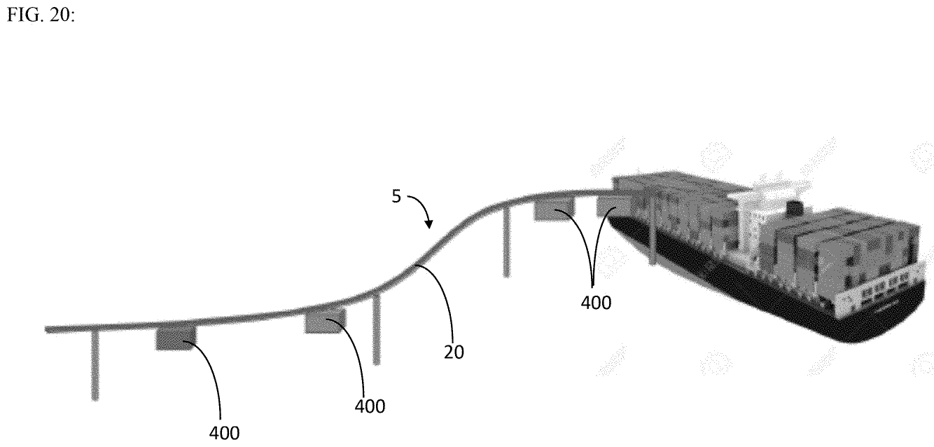

FIG. 20 schematically illustrates a magnetic rail system 5 configured to move intermodal shipping containers 400 in accordance with certain implementations described herein. The shipping containers 400 can have standard connection points for truck trailers to ship over land, and these connection points can be used to connect the couplers 30 to the shipping containers 400. The couplers 30 can be used as shuttles (e.g., portions that remain on the rails 20 and that separate from the shipping containers 400 when the shipping containers 400 have reached their destination) to move the shipping containers 400 along the rails 20 from a shipping yard to another mode of transportation (e.g., cargo ship; truck depot). The rails can use real estate under utility power lines without leveling the ground (e.g., the rails 20 do not require ground preparation).

The present invention has been described in several non-limiting implementations. It is to be understood that the implementations are not mutually exclusive, and elements described in connection with one implementation may be combined with, rearranged, or eliminated from, other implementations in suitable ways to accomplish desired design objectives. No single feature or group of features is necessary or required for each implementation.

For purposes of summarizing the present invention, certain aspects, advantages and novel features of the present invention are described herein. It is to be understood, however, that not necessarily all such advantages may be achieved in accordance with any particular implementation. Thus, the present invention may be embodied or carried out in a manner that achieves one or more advantages without necessarily achieving other advantages as may be taught or suggested herein.

As used herein any reference to “one implementation” or “some implementations” or “an implementation” means that a particular element, feature, structure, or characteristic described in connection with the implementation is included in at least one implementation. The appearances of the phrase “in one implementation” in various places in the specification are not necessarily all referring to the same implementation. Conditional language used herein, such as, among others, “can,” “could,” “might,” “may,” “e.g.,” and the like, unless specifically stated otherwise, or otherwise understood within the context as used, is generally intended to convey that certain implementations include, while other implementations do not include, certain features, elements and/or steps. In addition, the articles “a” or “an” or “the” as used in this application and the appended claims are to be construed to mean “one or more” or “at least one” unless specified otherwise.

Spatially relative terms, such as “above,” “below,” “over,” “under,” “upper,” and “lower” and the like, may be used herein for ease of description to describe one element or feature's relationship to another as illustrated in the figures. It will be understood that the spatially relative terms are intended to encompass different orientations of the components in use or operation in addition to the orientation depicted in the figures. For example, if a device in the figures is inverted, elements described as “above” or “over” other elements or features would then be oriented “below” or “beneath” the other elements or features. Thus, the exemplary term “above” can encompass both an orientation of above and below. The device may be otherwise oriented (e.g., rotated 90 degrees or at other orientations) and the spatially relative descriptors used herein interpreted accordingly. Similarly, the terms “upwardly,” “downwardly,” “vertical,” “horizontal,” and the like are used herein for the purpose of explanation only unless specifically indicated otherwise.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), or both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain implementations require at least one of X, at least one of Y, and at least one of Z to each be present.

Thus, while only certain implementations have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the implementations described therein.

What is claimed is:

1. A coupler configured to be attached to a magnetic levitation rail system, the coupler comprising:
at least one connector configured to controllably and repeatedly latch onto a body configured to contain at least one passenger and/or cargo and to controllably and repeatedly detach from the body;
at least one magnetic levitation motor configured to use magnetic levitation to propel the coupler along the magnetic levitation rail system;
at least one electrical conductor configured to be in electrical communication with an electrical power grid of the magnetic levitation rail system;
at least one battery configured to receive and store power from the electrical power grid via the at least one electrical conductor;
a plurality of wheels configured to be in mechanical communication with the magnetic levitation rail system; and
a motor subsystem in mechanical communication with the plurality of wheels, the motor subsystem configured to drive the plurality of wheels to propel the body along the magnetic levitation rail system.

2. The coupler of claim 1, wherein the at least one connector comprises a pair of mechanical grips.

3. The coupler of claim 1, wherein the at least one magnetic levitation motor comprises at least one two-dimensional room temperature superconducting magnetic material.

4. The coupler of claim 3, wherein the at least one two-dimensional room temperature superconducting magnetic material comprises graphene.

5. The coupler of claim 1, wherein the at least one electrical conductor comprises at least one magnetic induction coil configured to wirelessly receive power from the magnetic rail system.

6. The coupler of claim 1, wherein the motor subsystem comprises at least one motor and stabilization controls.

7. The coupler of claim 1, wherein the plurality of wheels and the motor subsystem are configured to accelerate the coupler to passive magnetic take-off speeds at which magnetic levitation of the coupler is activated.

8. The coupler of claim 1, wherein the plurality of wheels and the motor subsystem are configured to propel the coupler along the magnetic levitation rail system using power received from the at least one battery.

9. The coupler of claim 8, wherein the plurality of wheels and the motor subsystem are configured to be controllably activated in the event of loss of external power to the coupler.

10. The coupler of claim 1, further comprising at least one communication device configured to wirelessly transmit and/or receive signals to and/or from the magnetic levitation rail system.

11. The coupler of claim 1, further comprising a cable release mechanism configured to allow the body to be controllably lowered from the coupler.

12. The coupler of claim 1, further comprising at least one shock absorber configured to inhibit vibrations of the body while travelling along the magnetic levitation rail system.

13. The coupler of claim 1, further comprising a radial bearing swivel configured to allow an orientation of the body relative to the magnetic levitation rail system to be controllably adjusted.

14. A magnetic levitation track system comprising:
a plurality of track portions; and
at least one coupler in mechanical communication with the plurality of track portions and configured to travel along the plurality of track portions using magnetic levitation, the at least one coupler configured to controllably and repeatedly latch onto a body configured to contain at least one passenger and/or cargo and to controllably and repeatedly detach from the body.

15. The system of claim 11, wherein the at least one coupler comprises a tubular magnetic levitation motor comprising a first tube extending within a second tube.

16. The system of claim 15, wherein at least one of the first and second tubes comprising at least one two-dimensional room temperature superconducting magnetic material.

17. The system of claim 16, wherein the at least one two-dimensional room temperature superconducting magnetic material comprises graphene.

18. The system of claim 14, wherein the at least one coupler is a shuttle that remains on the plurality of track portions.
